(19) United States
(12) Patent Application Publication
(10) Pub. No.: US 2026/0046875 A1
(43) Pub. Date: Feb. 12, 2026

(54) UPLINK CONTROL INFORMATION MULTIPLEXING ON FREQUENCY DIVISION MULTIPLEXING CHANNELS

(71) Applicant: QUALCOMM INCORPORATED, San Diego, CA (US)

(72) Inventors: Mostafa Khoshnevisan, San Diego, CA (US); Yitao Chen, San Marcos, CA (US); Fang Yuan, Beijing (CN)

(21) Appl. No.: 19/102,388

(22) PCT Filed: Sep. 30, 2022
(86) PCT No.: PCT/CN2022/123173

§ 371 Date: Feb. 8, 2025

(51) Int. Cl. H04W 72/21; H04B 7/06

(52) U.S. Cl. CPC H04W 72/21; H04B 7/0626

(57) ABSTRACT

Methods, systems, and devices for wireless communications are described. Described techniques provide for procedures, conditions, and signaling, based on which a user equipment (UE) may determine whether to transmit uplink control information (UCI) via a single repetition or multiple repetitions when two frequency division multiplexed (FDM) repetitions are scheduled for a UE. For example, the network may indicate that the UE is to adopt a first behavior (e.g., transmit UCI via a single repetition) or a second behavior (e.g., transmit UCI via both repetitions). If the UE is configured to transmit the UCI via both repetitions, then the UE may determine if one or more conditions are satisfied. If such conditions are not met, then the UE may default to the first behavior. The UE may determine which behavior to apply based on explicit signaling from the network, a type of UCI, or a combination thereof.

### CROSS REFERENCE

This application is a 371 National Stage of PCT Application No. PCT/CN2022/123173, filed on Sep. 30, 2022, entitled “UPLINK CONTROL INFORMATION MULTIPLEXING ON FREQUENCY DIVISION MULTIPLEXING CHANNELS,” and assigned to the assignee hereof. The disclosure of the prior Application is considered part of and is incorporated by reference into this Patent Application.

### FIELD OF TECHNOLOGY

The following relates to wireless communications, including uplink control information multiplexing on frequency division multiplexing channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink control information (UCI) multiplexing on frequency division multiplexing (FDM) channels. For example, the described techniques provide for procedures, conditions, and signaling, based on which a UE may determine whether to transmit UCI via a single repetition or multiple repetitions when two FDM repetitions are scheduled for a user equipment (UE). For example, the network may indicate that the UE is to adopt a first behavior (e.g., transmit UCI via a single repetition) or a second behavior (e.g., transmit UCI via both reptations). If the UE is configured to transmit the UCI via both repetitions, then the UE may determine if one or more conditions are satisfied (in which case the UE may adopt the second behavior). If such conditions are not met, then the UE may default to the first behavior. In some cases (e.g., based on a rule or based on control signaling), the UE may determine which behavior to apply based on explicit signaling from the network, a type of UCI, or a combination thereof. If the UE defaults to, or is configured to apply, the first behavior, then the UE may select one of the two repetitions on which to multiplex the UCI based on one or more conditions (e.g., a sounding reference (SRS), redundancy version (RV), frequency range, etc.).

A method for wireless communications at a user equipment (UE) is described. The method may include receiving control signaling that schedules a first set of resource blocks (RBs) associated with a first transmission beam and a second set of RBs associated with a second transmission beam, where the first set of RBs and the second set of RBs occur during a first time interval, determining, based on the control signaling, whether to transmit UCI via one of the first set of RBs or the second set of RBs, or via both the first set of RBs and the second set of RBs, and transmitting the UCI via at least one of the first set of RBs or the second set of RBs based on the determining.

An apparatus for wireless communications at a UE is described. The apparatus may include a processor, memory coupled with the processor, and instructions stored in the memory. The instructions may be executable by the processor to cause the apparatus to receive control signaling that schedules a first set of RBs associated with a first transmission beam and a second set of RBs associated with a second transmission beam, where the first set of RBs and the second set of RBs occur during a first time interval, determine, based on the control signaling, whether to transmit UCI via one of the first set of RBs or the second set of RBs, or via both the first set of RBs and the second set of RBs, and transmit the UCI via at least one of the first set of RBs or the second set of RBs based on the determining.

Another apparatus for wireless communications at a UE is described. The apparatus may include means for receiving control signaling that schedules a first set of RBs associated with a first transmission beam and a second set of RBs associated with a second transmission beam, where the first set of RBs and the second set of RBs occur during a first time interval, means for determining, based on the control signaling, whether to transmit UCI via one of the first set of RBs or the second set of RBs, or via both the first set of RBs and the second set of RBs, and means for transmitting the UCI via at least one of the first set of RBs or the second set of RBs based on the determining.

A non-transitory computer-readable medium storing code for wireless communications at a UE is described. The code may include instructions executable by a processor to receive control signaling that schedules a first set of RBs associated with a first transmission beam and a second set of RBs associated with a second transmission beam, where the first set of RBs and the second set of RBs occur during a first time interval, determine, based on the control signaling, whether to transmit UCI via one of the first set of RBs or the second set of RBs, or via both the first set of RBs and the second set of RBs, and transmit the UCI via at least one of the first set of RBs or the second set of RBs based on the determining.

In some examples of the method, apparatuses, and non-transitory computer-readable medium described herein, transmitting the UCI may include operations, features, means, or instructions for transmitting the UCI via the first set of RBs or via both the first set of RBs and the second set of RBs based on the determining and on whether one or more conditions may be satisfied.

In some examples of the method, apparatuses, and non-transitory computer-readable medium described herein, transmitting the UCI may include operations, features, means, or instructions for transmitting the UCI via the first set of RBs or via both the first set of RBs and the second set of RBs based on whether a first quantity of RBs in the first set of RBs may be equal to a second quantity of RBs in the second set of RBs.

In some examples of the method, apparatuses, and non-transitory computer-readable medium described herein, transmitting the UCI may include operations, features, means, or instructions for transmitting the UCI via the first set of RBs or via both the first set of RBs and the second set of RBs based on whether a first quantity of PTRS ports associated with the first set of RBs may be equal to a second quantity of PTRS ports associated with the second set of RBs.

In some examples of the method, apparatuses, and non-transitory computer-readable medium described herein, transmitting the UCI may include operations, features, means, or instructions for transmitting the UCI via the first set of RBs or via both the first set of RBs and the second set of RBs based on whether a first PTRS density associated with the first set of RBs may be equal to a second PTRS density associated with the second set of RBs.

In some examples of the method, apparatuses, and non-transitory computer-readable medium described herein, transmitting the UCI may include operations, features, means, or instructions for transmitting the UCI via the first set of RBs or via both the first set of RBs and the second set of RBs based on whether a first quantity of resource elements of the first set of RBs may be equal to a second quantity of resource elements of the second set of RBs.

In some examples of the method, apparatuses, and non-transitory computer-readable medium described herein, transmitting the UCI may include operations, features, means, or instructions for transmitting the UCI via the first set of RBs or via both the first set of RBs and the second set of RBs based on whether one or more additional UCI messages may be scheduled during the first set of RBs or the second set of RBs.

Some examples of the method, apparatuses, and non-transitory computer-readable medium described herein may further include operations, features, means, or instructions for receiving second control signaling including an indication of a first trigger state associated with transmitting the UCI via one of the first set of RBs or the second set of RBs and a second trigger state associated with transmitting the UCI via both the first set of RBs and the second set of RBs.

Some examples of the method, apparatuses, and non-transitory computer-readable medium described herein may further include operations, features, means, or instructions for receiving, in the control signaling, an indication of the first trigger state or the second trigger state, and where the determining may be based on the indication of the first trigger state or the second trigger state.

In some examples of the method, apparatuses, and non-transitory computer-readable medium described herein, the UCI includes aperiodic channel state information, or semi-persistent channel state information associated with an uplink shared channel.

In some examples of the method, apparatuses, and non-transitory computer-readable medium described herein, the determining may include operations, features, means, or instructions for determining whether a type of the UCI may be associated with transmitting the UCI via the first set of RBs or transmitting the UCI via both the first set of RBs and the second set of RBs.

Some examples of the method, apparatuses, and non-transitory computer-readable medium described herein may further include operations, features, means, or instructions for receiving second control signaling scheduling the UCI on a physical uplink control channel that overlaps in time with the first set of RBs and the second set of RBs, where the type of the UCI may be associated with the physical uplink control channel.

Some examples of the method, apparatuses, and non-transitory computer-readable medium described herein may further include operations, features, means, or instructions for receiving third control signaling indicating that a first type of UCI may be associated with transmitting the UCI via one of the first set of RBs or the second set of RBs, and a second type of UCI may be associated with transmitting the UCI via both the first set of RBs and the second set of RBs, where the determining may be based on whether the type of the UCI may be the first type or the second type.

In some examples of the method, apparatuses, and non-transitory computer-readable medium described herein, the type of the UCI includes feedback information, a scheduling request, semi-persistent channel state information associated with a physical uplink control channel, or periodic channel state information.

In some examples of the method, apparatuses, and non-transitory computer-readable medium described herein, the determining may include operations, features, means, or instructions for determining to transmit the UCI via one of the first set of RBs or the second set of RBs and selecting one of the first set of RBs or the second set of RBs based on the determining, where the transmitting may be based on the selecting.

In some examples of the method, apparatuses, and non-transitory computer-readable medium described herein, the selecting may include operations, features, means, or instructions for selecting the first set of RBs based on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

Some examples of the method, apparatuses, and non-transitory computer-readable medium described herein may further include operations, features, means, or instructions for receiving second control signaling scheduling additional UCI via a control channel, where the determining includes determining to transmit the UCI via both the first set of RBs and the second set of RBs.

In some examples of the method, apparatuses, and non-transitory computer-readable medium described herein, transmitting the UCI may include operations, features, means, or instructions for transmitting the UCI and the additional UCI via the first set of RBs.

In some examples of the method, apparatuses, and non-transitory computer-readable medium described herein, transmitting the UCI may include operations, features, means, or instructions for transmitting the UCI via the first set of RBs and transmitting the additional UCI via the second set of RBs.

In some examples of the method, apparatuses, and non-transitory computer-readable medium described herein, transmitting the UCI may include operations, features, means, or instructions for transmitting the UCI via both the first set of RBs and the second set of RBs and transmitting the additional UCI via both the first set of RBs and the second set of RBs.

Some examples of the method, apparatuses, and non-transitory computer-readable medium described herein may further include operations, features, means, or instructions for identifying an error case based on receiving the control signaling scheduling the additional UCI and refraining from transmitting the additional UCI based on the error case.

A method for wireless communications at a network entity is described. The method may include transmitting control signaling that schedules a first set of RBs associated with a first transmission beam of a UE and a second set of RBs associated with a second transmission beam of the UE, where the first set of RBs and the second set of RBs occur during a first time interval, determining, based on the control signaling, whether to receive UCI via one of the first set of RBs or the second set of RBs, or via both the first set of RBs and the second set of RBs, and receiving the UCI via at least one of the first set of RBs or the second set of RBs based on the determining.

An apparatus for wireless communications at a network entity is described. The apparatus may include a processor, memory coupled with the processor, and instructions stored in the memory. The instructions may be executable by the processor to cause the apparatus to transmit control signaling that schedules a first set of RBs associated with a first transmission beam of a UE and a second set of RBs associated with a second transmission beam of the UE, where the first set of RBs and the second set of RBs occur during a first time interval, determine, based on the control signaling, whether to receive UCI via one of the first set of RBs or the second set of RBs, or via both the first set of RBs and the second set of RBs, and receive the UCI via at least one of the first set of RBs or the second set of RBs based on the determining.

Another apparatus for wireless communications at a network entity is described. The apparatus may include means for transmitting control signaling that schedules a first set of RBs associated with a first transmission beam of a UE and a second set of RBs associated with a second transmission beam of the UE, where the first set of RBs and the second set of RBs occur during a first time interval, means for determining, based on the control signaling, whether to receive UCI via one of the first set of RBs or the second set of RBs, or via both the first set of RBs and the second set of RBs, and means for receiving the UCI via at least one of the first set of RBs or the second set of RBs based on the determining.

A non-transitory computer-readable medium storing code for wireless communications at a network entity is described. The code may include instructions executable by a processor to transmit control signaling that schedules a first set of RBs associated with a first transmission beam of a UE and a second set of RBs associated with a second transmission beam of the UE, where the first set of RBs and the second set of RBs occur during a first time interval, determine, based on the control signaling, whether to receive UCI via one of the first set of RBs or the second set of RBs, or via both the first set of RBs and the second set of RBs, and receive the UCI via at least one of the first set of RBs or the second set of RBs based on the determining.

In some examples of the method, apparatuses, and non-transitory computer-readable medium described herein, receiving the UCI may include operations, features, means, or instructions for the UCI via the first set of RBs, or via both the first set of RBs and the second set of RBs based on the determining and on whether one or more conditions may be satisfied.

Some examples of the method, apparatuses, and non-transitory computer-readable medium described herein may further include operations, features, means, or instructions for transmitting second control signaling including an indication of a first trigger state associated with receiving the UCI via one of the first set of RBs or the second set of RBs and a second trigger state associated with receiving the UCI via both the first set of RBs and the second set of RBs.

In some examples of the method, apparatuses, and non-transitory computer-readable medium described herein, the determining may include operations, features, means, or instructions for determining whether a type of the UCI may be associated with receiving the UCI via the first set of RBs, or receiving the UCI via both the first set of RBs and the second set of RBs.

In some examples of the method, apparatuses, and non-transitory computer-readable medium described herein, the determining may include operations, features, means, or instructions for determining to receive the UCI via one of the first set of RBs or the second set of RBs and selecting one of the first set of RBs or the second set of RBs based on the determining, where the receiving may be based on the selecting.

In some examples of the method, apparatuses, and non-transitory computer-readable medium described herein, the selecting may include operations, features, means, or instructions for selecting the first set of RBs based on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

Some examples of the method, apparatuses, and non-transitory computer-readable medium described herein may further include operations, features, means, or instructions for transmitting second control signaling scheduling additional UCI via a control channel, where the determining includes determining to receive the UCI via both the first set of RBs and the second set of RBs.

### BRIEF DESCRIPTION OF THE DRAWINGS

FIG. 1 illustrates an example of a wireless communications system that supports uplink control information (UCI) multiplexing on frequency division multiplexing (FDM) channels in accordance with one or more aspects of the present disclosure.

FIG. 2 illustrates an example of a wireless communications system that supports UCI multiplexing on FDM channels in accordance with one or more aspects of the present disclosure.

FIG. 3 illustrates an example of a timeline that supports UCI multiplexing on FDM channels in accordance with one or more aspects of the present disclosure.

FIG. 4 illustrates an example of a process flow that supports UCI multiplexing on FDM channels in accordance with one or more aspects of the present disclosure.

FIGS. 5 and 6 show block diagrams of devices that support UCI multiplexing on FDM channels in accordance with one or more aspects of the present disclosure.

FIG. 7 shows a block diagram of a communications manager that supports UCI multiplexing on FDM channels in accordance with one or more aspects of the present disclosure.

FIG. 8 shows a diagram of a system including a device that supports UCI multiplexing on FDM channels in accordance with one or more aspects of the present disclosure.

FIGS. 9 and 10 show block diagrams of devices that support UCI multiplexing on FDM channels in accordance with one or more aspects of the present disclosure.

FIG. 11 shows a block diagram of a communications manager that supports UCI multiplexing on FDM channels in accordance with one or more aspects of the present disclosure.

FIG. 12 shows a diagram of a system including a device that supports UCI multiplexing on FDM channels in accordance with one or more aspects of the present disclosure.

FIGS. 13 through 16 show flowcharts illustrating methods that support UCI multiplexing on FDM channels in accordance with one or more aspects of the present disclosure.

### DETAILED DESCRIPTION

Some wireless communications systems may support uplink repetitions that are frequency division multiplexed (FDM) in a same time interval (e.g., a same set of time intervals). A first set of resource blocks (RBs) associated with a first beam and a first antenna panel and a second set of RBs associated with a second beam and a second antenna panel may be granted for a UE. The UE may also be triggered to transmit uplink control information (UCI) (e.g., channel state information (CSI), feedback signaling, etc.) during the same time interval. The UE may not have a mechanism for determining whether to transmit the UCI via both of the sets of RBs (e.g., multiplexed with both uplink repetitions), or via a single set of RBs (e.g., multiplexed with a single uplink repetition). If the UE determines (e.g., or is instructed) to transmit the UCI via single set of RBs, then the UE may not have a mechanism for determining which set of RBs to select for transmitting the UCI. Some wireless communications systems may not support any mechanism for the UE and the network entity to determine whether UCI will be transmitted via both repetitions or one repetition, or for selecting which repetition to use (e.g., in the case where only one repetition is selected).

Techniques described herein provide procedures, conditions, and signaling, based on which a UE may determine whether to transmit UCI via a single repetition or multiple repetitions when two FDM repetitions are scheduled for the UE. For example, the network may indicate that the UE is to adopt a first behavior (e.g., transmit UCI via a single repetition) or a second behavior (e.g., transmit UCI via both reptations). If the UE is configured to transmit the UCI via both repetitions, then the UE may determine if one or more conditions are satisfied (in which case the UE may adopt the second behavior). If such conditions are not met, then the UE may default to one of the behaviors (e.g., the first behavior). In some cases (e.g., based on a rule or based on control signaling), the UE may determine which behavior to apply based on explicit signaling from the network, a type of UCI, or a combination thereof. If the UE defaults to, or is configured to apply, the first behavior, then the UE may select one of the two repetitions on which to multiplex the UCI based on one or more conditions (e.g., a sounding reference (SRS), redundancy version (RV), frequency range, etc.).

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to UCI multiplexing on FDM channels.

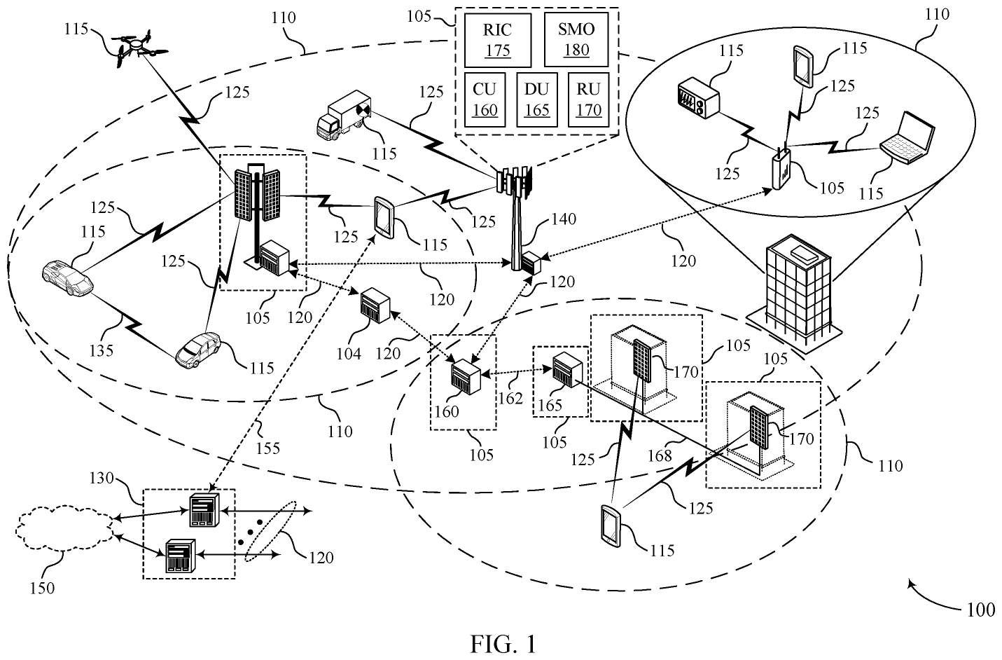

FIG. 1 illustrates an example of a wireless communications system 100 that supports UCI multiplexing on FDM channels in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support UCI multiplexing on FDM channels as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a UE 115 may receive (e.g., from a network entity 105) an uplink DCI (e.g., a DCI message granting resources for an uplink transmission). The DCI may trigger CSI reporting (e.g., an aperiodic (AP) CSI report) on a PUSCH. Up to 128 trigger states may be configured via RRC signaling (e.g., higher layer parameter AperiodicTriggerStateList). Each trigger state in the list of trigger states may be linked to one or more (e.g., up to 16) CS report settings. If a CSI request field (e.g., in the DCI message) has a number of bits (e.g., N bits), then up to 2^{N-1} trigger states can be activated via MAC-CE singling (e.g., mapping to up to 63 codepoints for N=6. If the CSI request field indicates all 0s, then no CSI report is triggered. The CSI request field of the uplink DCI may indicate on trigger state (e.g., which triggers one or more CSI reports). The value of a codepoint of the CSI request field in the uplink DCI may therefore indicate a trigger state (e.g., an aperiodic trigger state for an AP CSI report), and may trigger one or more CSI reports.

In some examples, the wireless communications system 100 may support single-DCI based PUSCH repetitions (e.g., in a time division multiplexing (TDM) manner). Each repetition may correspond to a different set of transmission parameters (e.g., different beams, different spatial relations, different transmission configuration indicator (TCI) states, different power control parameters, different precoding configurations or precoders, among other examples). Each repetition may be associated with a same transport block (TB). To support such repetitions, two sets of repetitions may correspond to two different sounding reference signal (SRS) resource sets. THE DCI may indicate two sets of transmission parameters (e.g., two beams, two sets of power control parameters, among other examples) via two corresponding SRI fields for both codebook based transmissions and non-codebook based transmissions. For codebook based PUSCHs, the DCI may include two TMPI fields to indicate two precoders for the two sets of repetitions. The two sets of repetitions may be cyclical (e.g., may alternate in time between repetitions of the first set of repetitions and repetitions of the second set of repetitions), or the first set of repetitions may precede the second set of repetitions.

The UE 115 may transmit uplink control signaling (UCI, such as A-CSI, semi-persistent CSI (SP-CSI), among other examples) on a PUSCH using beam diversity. Such UCI may be transmitted on a PUSCH and carried only on a first PUSCH repetition (e.g., in the case of a single transmit receive point (TRP), where all repetitions are associated with one SRS resource set). In some examples, a UE may transmit multiple repetitions in a multiple TRP (mTRP) deployment, in which case the UE may be configured to carry A-CSI or SP-CSI on two PUSCH repetitions. An A-CSI may be multiplexed on the first repetition from the first set of repetitions and on the first repetition from the second set of repetitions if one or more conditions are satisfied (e.g., if the two repetitions have the same length, and if other UCIs other than the A-CSI are not multiplexed on any of the two PUSCH repetitions. Otherwise (e.g., according to a fallback or default behavior), the A-CSI may be multiplexed on the first repetition. When the CSI is multiplexed on two repetitions, the UE 115 may not expect a different number of actual PTRS ports for the two repetitions. Such behavior may be followed when the triggered state (e.g., indicated in the CSI request field of the DCI message that schedules the PUSCH) may be enabled with such behavior.

Such conditions may support multiplexing of CSI on two PUSCH repetitions (e.g., that are TDM). For UCI, a mother code rate of the polar code (e.g., on which the encoding is based) may be based on a number of resource elements (Res) that are available for UCI multiplexing. The Rex that are available for UCI multiplexing may be a function of an available number of Res of PUSCH excluding DMRS symbols (e.g., all Res of a DMRS symbol) and PTRS REs, and a presence of other UCIs (e.g., other than the A-CSI or SP-CSI requested by the DCI that schedules the PUSCH). If the mother code for the UCI to be multiplexed on the two repetitions is not the same, the receiver (e.g., the network entity 105) may not be able to soft combine the repetitions, and the UE complexity may be increased as two rate matching and two encodings may be performed to transmit the UCI.

The other UCIs that may conflict with scheduled UCI may refer to UCIs that are originally scheduled or configured to be transmitted on ta PUCCH, but because the PUCCH overlaps with one of the TDM PUSCH repetitions, the conflicting UCI may be multiplexed on that PUSCH repetition (e.g., which may be different from UCI such as A-CSI or SP-CSI on a PUSCH that are triggered by the DCI scheduling or activating the PUSCH). Other UCI may include HARQ-Ack signaling, periodic CSI, SP-CSI on a PUCCH (e.g., activated by a MAC-CE), scheduling requests (SRs), among other examples). TDM PUSCH repetitions may not apply to such UCI (e.g., scheduled on a PUCCH) because TDM PUSCH repetitions may not overlap with such UCI. Techniques described herein for FDM PUSCH repetitions may support multiplexing of such UCI in one or both repetitions.

As described herein, without a mechanism for multiplexing UCI onto one or multiple PUSCH repetitions that are FDMed, the UE may fail to transmit UCI, or may the network entity may fail to monitor for or receive UCI, which may result in an increase in retransmissions, an increase in failed data or control signaling, decreased throughput, increased system latency, and decreased user experience.

Techniques described herein provide procedures, conditions, and signaling, based on which a UE 115 may determine whether to transmit UCI via a single repetition or multiple repetitions when two FDM repetitions are scheduled for the UE 115. For example, the network may indicate that the UE115 is to adopt a first behavior (e.g., transmit UCI via a single repetition) or a second behavior (e.g., transmit UCI via both reptations). If the UE is configured to transmit the UCI via both repetitions, then the UE 115 may determine if one or more conditions are satisfied (in which case the UE may adopt the second behavior). If such conditions are not met, then the UE may default to one of the behaviors (e.g., the first behavior). In some cases (e.g., based on a rule or based on control signaling), the UE 115 may determine which behavior to apply based on explicit signaling from the network, a type of UCI, or a combination thereof. If the UE 115 defaults to, or is configured to apply, the first behavior, then the UE 115 may select one of the two repetitions on which to multiplex the UCI based on one or more conditions (e.g., a SRS resource set, an RV, a frequency range, etc.).

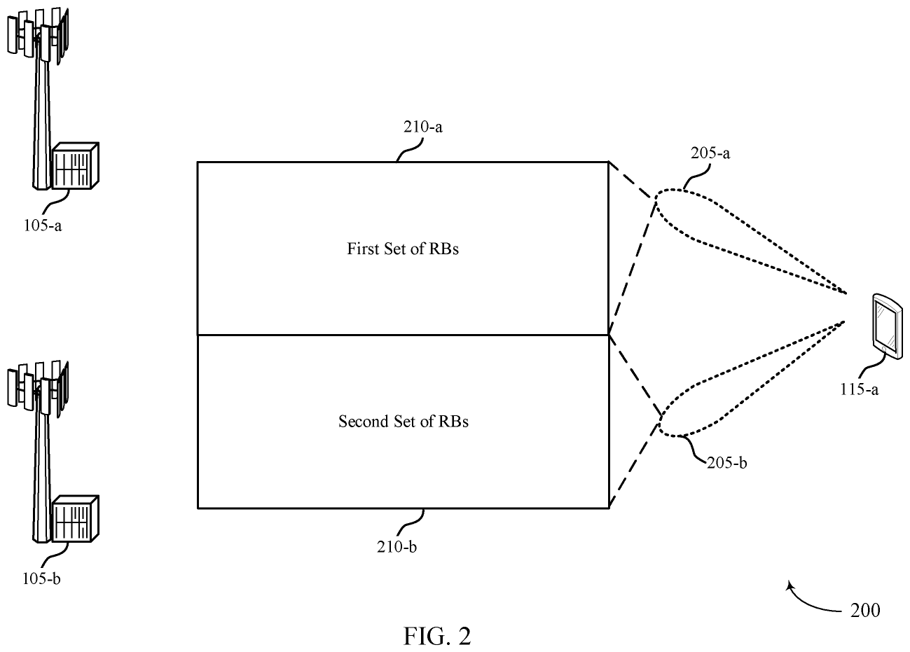

FIG. 2 illustrates an example of a wireless communications system 200 that supports UCI multiplexing on FDM channels in accordance with one or more aspects of the present disclosure. Wireless communications system 200 may implement aspects of, or be implemented by aspects of, the wireless communications system 100. For example, the wireless communications system 200 may include one or more network entities 105 (e.g., the network entity 105-a and the network entity 105-b) and one or more UEs 115 (e.g., the UE 115-a), which may be examples of corresponding devices described with reference to FIG. 1. The UE 115-a may communicate with the network entity 105-a and the network entity 105-b. For instance, the UE 115-a may operate in an mTRP deployment, in which case the UE 115-a may transmit one or more uplink messages (e.g., a first repetition and a second repetition of a TB) to both the network entity 105-a and the network entity 105-b. In such examples, the UE 115-a may transmit a first repetition to the network entity 105-a via the beam 205-a and the second repetition to the network entity 105-b via the beam 205-b.

The wireless communications system 200 may support single-DCI FDM physical uplink shared channel (PUSCH) signaling. In some examples of FDM PUSCH communications, a single DCI may schedule a PUSCH with two sets of RBs (e.g., the first set of RBs 210-a and the second set of RBs 210-b). The DCI may schedule the first repetition to be transmitted by the UE 115-a via a first antenna panel using the first beam 205-a (e.g., using a first precoder, a first set of power control parameters, etc.), and the second repetition to be transmitted by the UE 115-b via a second antenna panel using the second beam 205-b (e.g., using a second precoder, a second set of power control parameters, etc.). Each of the first set of RBs 210-a and the second set of RBs 210-b may be associated with different SRS resource sets. In some examples, the first set of RBs 210-a and the second set of RBs 210-b may be associated with a single RV (e.g., for joint rate matching across the first set of RBs 210-a and the second set of RBs 210-b), or the first set of RBs 210-a may be associated with a first RV and the second set of RBs 210-b may be associated with a second RV (e.g., supporting repetitions and separate rate matching across the first set of RBs 210-a and the second set of RBs 210-b). The DCI may include an SRS resource set indicator field, two SRS fields, and two TPMI fields (e.g., for the two repetitions).

The two repetitions may at least partially overlap in time (e.g., may occupy one or more of the same time intervals, such as one or more symbols). In some examples, the UE 115-a may also be configured to transmit UCI (e.g., triggered to transmit UCI such as aperiodic CSI or semi-persistent channel state information (SP-CSI), or UCI may be scheduled in a physical uplink control channel (PUCCH) that overlaps in time with the first set of RBs 210-a and the second set of RBs 210-b) during the one or more symbols in which the first set of RBs 210-a and the second set of RBs 210-b are scheduled. Without configuration information from a network entity 105, or without rules, or both, the UE 115-a may not be able to successfully multiplex the UCI with the first set of RBs 210-a, the second set of RBs 210-b, or both. As described herein, the UE 115-a may be configured to transmit to transmit the UCI via both the first set of RBs 210-a and the second set of RBs 210-b, but may not be able to do so based on a number of RBs allocated to each PUSCH repetition, a PTRS frequency density, an actual number of PTRS ports in each of the two sets of RBs 210, or based on other conflicting UCI. In such examples, the UE 115-a may fall back to a default behavior (e.g., may transmit the UCI one of the first set of RBs 210-a or the second set of RBs 210-b). However, if configured to transmit the UCI via only one of the two sets of RBs 210, or if falling back to the default behavior despite having been configured to transmit the UCI via both of the sets of RBs 210, the UE 115-a may not have information indicating which of the two sets of RBs 210 the UE 115-a is to select. For UCI signaling (e.g., for UCI originally scheduled on a PUCCH but that re multiplexed with the PUSCH due to overlap in time or frequency or both), the UE 115-a may determine whether to multiplex the additional UCI on both PUSCH repetitions or only one PUSCH repetition. In case of conflict with such additional UCI (e.g., some UCI is to be multiplexed on both repetitions and some UCI is to be multiplexed on a single repetition), the UE may determine a transmission configuration for all of the UCI. Techniques described herein provide rules, conditions, signaling, or a combination thereof, supporting such determinations by the UE 115-a (e.g., the UE 115-a may determine when to transmit UCI via both repetitions, and when to transmit the UCI via a single repetition).

For FDM PUSCH consisting of two sets of RBs 210 (e.g., the first set of RBs 210-a and the second set of RBs 210-b) corresponding to two PUSCH repetitions (e.g., that are associated with different SRS resources and different sets of transmission parameters, such as different beams 205 and different sets of transmission parameters), the UE 115-a may configured to multiplex one or more UCIs on both the PUSCH repetitions (e.g., which may be referred to as behavior 1), or may be configured to multiplex the one or more UCIs on only one of the PUSCH repetitions (e.g., which may be referred to as behavior 0). Configuration of whether the UE 115-a is to multiplex the UCI with one repetition or both repetitions may be indicated via control signaling (e.g., RRC signaling, MAC-CE signaling, DCI signaling, or any combination thereof), as described herein.

If the UE 115-a is configured to multiplex the one or more UCIs on both the PUSCH repetitions (e.g., via the first set of RBs 210-a and the second set of RBs 210-b) (e.g., behavior 1), the UE 115-a may determine whether one or more conditions are satisfied. If the conditions are satisfied, the UE 115-a may multiplex the UCI on both repetitions (e.g., behavior 1, per the configuration). However, if one or more of the conditions are not satisfied, the UE 115-a may fall back to a default behavior (e.g., behavior 0).

For example, the UE 115-a may adopt behavior 1 if the first set of RBs 210-a and the second set of RBs 210-b have the same number of RBs (e.g., a first condition is satisfied). In some examples, the UE 115-a may default to behavior 0 if the first set of RBs 210-a and the second set of RBs 210-b do not have the same number of RBs (e.g., a first condition is not satisfied). In some cases, RBs may be assigned based on a frequency domain resource allocation (FDRA) field in a scheduling DCI message, which may indicate a number (e.g., N) of allocated RBs for a PUSCH from which a first number of RBs (e.g., ^{N}/₂ RBs) are assigned to the first set of RBs and the remaining number of RBs (e.g., ^{N}/₂ RBs) are assigned to second set of RBs. In such examples, if N is an odd value (e.g., is not an even value), then the two sets of RBs do not have an equal number of RBs (e.g., the UE 115-a may determine that the first condition is not satisfied).

In some examples, the UE 115-a may adopt behavior 1 if the first set of RBs 210-a and the second set of RBs 210-b are associated with a same number of PTRS ports (e.g., 0 PRS ports, 1, PTRS port, or 2 PTRS ports for each of the two sets of RBs 210) (e.g., a second condition is satisfied). If the two sets of RBs 210 are associated with different numbers of RBs (e.g., the second condition is not satisfied), then the UE 115-a may default to behavior 0 (e.g., despite being configured to transmit the UCI via both sets of RBs 210). The actual number of PTRS ports associated with each set of RBs 210 may depend on a corresponding indicated SRI or TPMI for the respective set of RBs 210. Given that DCI messages may indicate two SRIs, two TPMIs, or both for the two sets of RBs 210, it may be possible to have different actual number of PTRS ports (e.g., in which case, the second condition may not be satisfied).

In some examples, the UE 115-a may adopt behavior 1 if the first set of RBs 210-a and the second set of RBs 210-b are associated with a same PTRS density in frequency (e.g., a third condition is satisfied). In some cases, it may be possible for the first set of RBs 210-a to have a different PTRS density in the frequency domain than the second set of RBs 210-b. The UE 115-a may adopt behavior 0 if the first set of RBs 210-a and the second set of RBs 210-b are associated with a different PTRS density in frequency (e.g., the third condition is not satisfied).

In some examples, the UE 115-a may adopt behavior 1 if an available number of resource elements of the PUSCH (e.g., excluding one or more resources, such as DMRS symbols and PTRS resource elements) is the same for the first set of RBs 210-a and the second set of RBs 210-b (e.g., a fourth condition is satisfied). In some examples, one or more other conditions may not be satisfied, but the UE 115-a may still adopt behavior 1 if the fourth condition is satisfied. For instance, one or more of the first condition (e.g., the first set of RBs 210-a and the second set of RBs 210-b have the same number of RBs), the second condition (e.g., the first set of RBs 210-a and the second set of RBs 210-b are associated with a same number of PTRS ports), the third condition (e.g., the first set of RBs 210-a and the second set of RBs 210-b are associated with a same PTRS density in frequency) may not be satisfied. However, if the fourth condition is satisfied, the UE 115-a may still adopt behavior 1. Similarly, if the first condition, the second condition, and the third condition are satisfied, then the UE 115-a may determine that the fourth condition is also satisfied. Thus, in some examples, the UE 115-a may determine whether to adopt behavior 1 or behavior 0 (e.g., when configured to adopt behavior 1) based on whether any one, or all of, the first condition, the second condition, or the third condition are satisfied (e.g., as indicated via control signaling, or as defined in one or more standards documents, among other examples). In some examples, the UE 115-a may determine whether to adopt behavior 1 or behavior 0 based on whether the fourth condition is satisfied (e.g., without reference to the first condition, the second condition, or the third condition) (e.g., as indicated via control signaling, or as defined in one or more standards documents, among other examples).

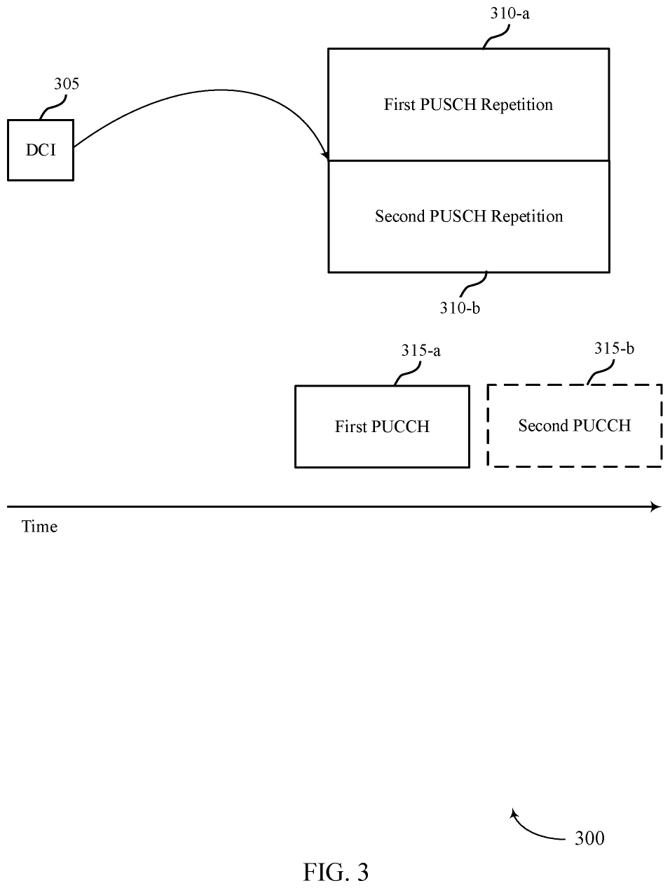

In some examples, the UE 115-a may adopt behavior 1 if the one or more scheduled UCIs are the only UCIs that are multiplexed on either of the PUSCH repetitions corresponding to the first set of RBs 210-a and the second set of RBs 210-b (e.g., a fifth condition is satisfied). For example, if another UCI is scheduled or triggered for transmission via the first set of RBs 210-a or the second set of RBs 210-b, or both, the fifth condition may not be satisfied. The fifth condition may ensure that no other UCIs are being multiplexed on only one of the PUSCH repetitions (e.g., on only one of the first set of RBs 210-a and the second set of RBs 210-b). In some examples, as described in greater detail with reference to FIG. 3, the UE 115-a may drop one or more UCIs, or may multiplex one or more UCIs, or a combination thereof, based on detecting additional UCIs scheduled for transmission via the first set of RBs 210-a or the second set of RBs 210-b, or both.

Although described with reference to five conditions, the UE 115-a may determine whether to adopt behavior 1 or behavior 0 using any number of conditions (e.g., which may or may not be the same as the conditions described herein). The UE 115-a may consider one, multiple, all, or some, of the conditions in determining which behavior to adopt.

When the UE 115-a is configured to multiplex the one or more UCIs on both PUSCH repetitions (e.g., via the first set of RBs 210-a and the second set of RBs 210-b) but one or more conditions are not satisfied (e.g., one, multiple, all, or any of the first condition, the second condition, the third condition, the fourth condition, and the fifth condition described herein), the UE 115-a may adopt a fallback behavior (e.g., behavior 0), and may transmit the one or more UCIs via a single set of RBs 210 (e.g., instead of via both sets of RBs 210). Or, the UE 115-a may be configured to multiplex the one or more UCIs via only one of the PUSCH repetitions (e.g., behavior 0). In any such examples, the UE 115-a may determine which of the PUSCH repetitions (e.g., which of the first set of RBs 210-a and the second set of RBs 210-b) with which to multiplex the UCI.

In some examples, the UE 115-a may select a set of RBs 210 on which to transmit the one or more UCIs based on an SRS resource set associated with the respective sets of RBs 210. For example, the UE 115-a may select the set of RBs 210 associated with the first SRS resource set.

The UE 115-a may select a set of RBs 210 on which to transmit the one or more UCIs based on a frequency range associated with each set of RBs 210. For example, the UE 115-a may transmit the one or more UCIs via the set of RBs 210 having the higher frequency (e.g., the first set of RBs 210-a), or having the lower frequency (e.g., the second set of RBs 210-b).

The UE 115-a may select a set of RBs 210 on which to transmit the one or more UCIs based on an RV value associated with each PUSCH repetition. For example, the first set of RBs 210-a may be associated with a first RV (e.g., RV=0), and the second set of RBs 210-b may be associated with a second RV (e.g., RV=2). The UE 115-a may multiple the UCI to the set of RBs 210 having the higher RV value (e.g., the second set of RBs 210-b) because RV=0 may carry systematic bits associated with the PUSCH, and multiplexing of the UCI with the repetition of the PUSCH using RV=0 may result in a smaller number of systematic bits for the PUSCH payload.

The UE 115-a may select a set of RBs 210 on which to transmit the one or more UCIs based on which repetition is associated with a larger number of RBs, or a larger number of available resource elements (e.g., excluding DMRS symbols and PTRS resource elements). The UE 115-a may select the set of RBs 210 that has the larger number of available resource elements, or the smaller number of PTRS resource elements. This may occur, for instance, in cases where the UE 115-a default to the fallback behavior (e.g., behavior 0) because one of the conditions are not satisfied.

The UE 115-a may select a set of RBs 210 on which to transmit the one or more UCIs based on determining which set of RBs 210 does not include one or more additional UCIs (e.g., other than the one or more UCIs for which the UE 115-a is determining a set of RBs 210). For example, the UE 115-a may determine that one or more conditions are not satisfied (e.g., another UCI is scheduled or triggered during the time interval associated with the first set of RBs 210-a and the second set of RBs 210-b), and may default to behavior 0. In such examples, the UE 115-a may select a set of RBs 210 on which to transmit the initial UCIs to balance the UCI payload that is multiplexed on each of the two PUSCH repetitions. In some examples, the UE 115-a may select the set of RBs 210 on which the additional UCIs are scheduled (e.g., the conflicting UCIs) to keep all UCIs in the same PUSCH repetition (e.g., which may support joint encoding of the UCIs).

As described herein, the network (e.g., via one or more TRPs) may configure the UE 115-a with behavior 1 or behavior 0 (e.g., and the UE 115-a may default to behavior 0 even inf the case of being configured with behavior 1 if one or more conditions are not met). The network may configure the UE 115-a with one of the behaviors via control signaling (e.g., RRC signaling, MAC-CE signaling, DCI signaling, or any combination thereof), or the UE 115-a may apply a fixed behavior depending on UCI type. Configuration, as described herein, may refer to configuration by the network (e.g., via control signaling), or may refer to fixed behaviors defined in one or more standards documents, which may apply to specific types of UCI behaviors.

In some examples, the UCI may include aperiodic CSI, or SP-CSI on a PUSCH. In such examples, RRC signaling may enable behavior 1 per trigger state, and a DCI message (e.g., a DCI message that schedules the PUSCH and triggers the CSI) may indicate a trigger state. For instance, the UE 115-a may receive RRC signaling enabling (e.g., activating, or configuring) behavior 1 (e. g, supporting transmission of the triggered UCI via both the first stet of RBs 210-a and the second set of RBs 210-b). In such examples, the RRC signaling may also indicate that behavior 1 is associated with a trigger state. Subsequently, the UE 115-a may receive a DCI message indicating the trigger state associated with behavior 1 (e.g., as indicated in the RRC signaling enabling behavior 1). If the DCI message indicates a trigger state that enables behavior 1, then the UE 115-a may transmit the UCI (e.g., an aperiodic CSI) via both the first set of RBs 210-a and the second set of RBs 210-b (e.g., may multiplex the aperiodic CSI on both repetitions, unless the one or more conditions are not satisfied, in which case the UE 115-a may apply the fallback behavior, such as behavior 0). In some examples, if the indicated trigger state is not enabled with behavior 1 (e.g., a second trigger state associated with behavior 0, as configured via RRC signaling, or the absence of the trigger state associated with behavior 1, among other examples), then the UE 115-a may apply behavior 0.

In some examples, the UCI may include feedback signaling (e.g., HARQ-ACK signaling, a scheduling request (SR), SP-CSI on a PUCCH, or periodic CSI). In such examples, the configuration of behaviors for the UCI may be common all such UCI types (e.g., UCI that is initially scheduled on a PUCCH that overlaps at least partially in time with the sets of RBs 210). For instance, the UE 115-a may multiplex any UCI type that is originally scheduled on a PUCCH and is multiplexed with the PUSCH due to overlap according to a behavior associated with such UCIs. For instance, behavior 1, or behavior 0, may be associated with any UCI that is scheduled or triggered on a PUCCH that overlaps in part with the sets of RBs. Such a rule or condition may be indicated via control signaling (e.g., RRC signaling), or may be included in one or more standards documents. Thus, for any UCI scheduled or triggered on a PUCCH that overlaps in time with the set of RBs 210, the UE 115-a may adopt the behavior associated with such UCI.

In some examples, the configuration of behaviors for the UCI may be UCI-type specific (e.g., the UE 115-a may be configured to multiplex HARQ-ACK on both repetitions, but to multiplex the periodic CSI on only one repetition, among other examples). For instance, for UCI including HARQ-ACK, the UE 115-a may adopt a fixed behavior (e.g., behavior 1 or behavior 0) associated with HARQ-ACK UCI. The behavior for HARQ-ACK UCI may be RRC configured or included in one or more standards documents, or may be indicated in the DCI message that schedules the PUCCH for HARQ-ACK (e.g., a different DCI message than the DCI message that schedules the FDM PUSCH for the sets of RBs 210). For UCI including SP-CSI on the PUCCH, the UE 115-a may adopt a fixed behavior (e.g., behavior 1 or behavior 0) associated with SP-CSI on a PUCCH. The behavior for SP-CSI may be RRC configured, indicated in one or more standards documents, or indicated in the MAC-CE that activates the SP-CSI. For UCI including periodic CSI, the UE 115-a may adopt a fixed behavior (e.g., behavior 1 or behavior 0) associated with periodic CSI. The behavior for SP-CSI may be RRC configured, or indicated in one or more standards documents.

As described in greater detail with reference to FIG. 3, the UE 115-a may identify some conflict between a first set of one or more UCIs configured with behavior 1, and an additional (e.g., second) set of one or more UCIs configured with behavior 0. In some examples, the UE 115-a may address the conflict by defaulting to behavior 0 for both UCIs. For instance, the UE 115-a may apply the fallback behavior (e.g., behavior 0) for the one or more UCIs (e.g., because the fifth condition is not satisfied). In such examples, the UE 115-a may transmit the first set of one or more UCIs, and the second set of one or more (e.g., conflicting) UCIs according to behavior 0 (e.g., the UE 115-a may transmit the first set of UCIs via the first set of RBs 210-a and the second set of UCIs via the second set of RBs 210-b, or may transmit both the first and second sets of UCIs via one of the sets of RBs 210). In some examples, the UE 115-a may ensure that the fifth condition is satisfied by apply behavior 1 to both sets of UCIs. In such examples, the UE 115-a may multiplex the first and second sets of UCIs via both PUSCH repetitions to resolve the conflict. In some examples, the UE 115-a may determine that such a scenario is an error case (e.g., the fifth condition is not satisfied), and may not transmit the UCI via either set of RBs 210 (e.g., may drop one or both sets of UCIS).

FIG. 3 illustrates an example of a timeline 300 that supports UCI multiplexing on FDM channels in accordance with one or more aspects of the present disclosure. Timeline 300 may implement aspects of, or be implemented by aspects of, wireless communications system 100 and wireless communications system 200. For example, one or more network entities 105 (e.g., one or more TRPs in an mTRP deployment) and one or more UEs 115, which may be examples of corresponding devices described with reference to FIGS. 1-2, may communicate with each other according to the timeline 300.

As described herein, in some cases, a UE may receive a DCI 305, which may schedule a first PUSCH repetition 310-a (e.g., via a first set of RBs 210-a) and a second PUSCH repetition 310-b (e.g., via a second set of RBs 210-b). The DCI may, in some cases, schedule or trigger one or more UCIs, which may be configured for transmission according to behavior 1 or behavior 0. In some examples, UCI may be scheduled on a PUCCH 315, and may be configured for behavior 0 or behavior 1. In some cases, UCI associated with behavior 1 may conflict with UCI associated with behavior 0.

For example, the first PUCCH 315-a may carry HARQ-ACK UCI configured for behavior 1, and the second PUCCH 315-b may carry a SR or CSI configured for behavior 0 (e.g., via control signaling, or according to a fixed behavior defined in a standards document, as described in greater detail with reference to FIG. 2). Both the first PUCCH 315-a and the second PUCCH 315-b may overlap in time (e.g., at least partially) with the PUSCH repetitions 310.

In some examples, the DCI 305 may trigger aperiodic CSI (e.g., or SP CSI) to be multiplexed on the FDM PUSCH (e.g., the PUSCH repetitions 310), and the CSI trigger state may be enabled (e.g., via RRC signaling) with behavior 1. There may also be a PUCCH (e.g., the first PUCCH 315-a) carrying HARQ-ACK, an SR, or CSI that overlaps in time at least partially with the PUSCH, where the UCI of the first PUCCH 315-a may be configured with behavior 0.

In some examples, the DCI 305 may trigger aperiodic CSI (e.g., or SP-CSI) to be multiplexed on an FDM PUSCH (e.g., the PUSCH repetitions 310), and the indicated CSI trigger state may not enable the behavior 1 (e.g., in which case, the PUSCH repetitions 310 are configured with behavior 0). There may also be a PUCCH (e.g., the first PUCCH 315-a) carrying HARQ-ACK, an SR, or CSI, that overlaps in time at least partially with the PUSCH, and the UCI of the first PUCCH 315-a may be configured with behavior 1.

In examples of conflicting UCI behaviors, such as those described with reference to FIG. 3, the UE may address the conflict by transmitting the UCI configured for behavior 1 according to behavior 0, transmitting the UCI configured for behavior 0 according to behavior 1, or treating the conflict as an error case. For instance, the UE may determine that a first set of one or more UCIs are configured to be multiplexed on both the first PUSCH repetition 310-a and the second PUSCH repetition 310-b according to behavior 1, but that a second set of one or more UCIs are configured to be multiplexed with only one PUSCH repetition 310 according to behavior 0. In some examples, the UE may multiplex the first set of one or more UCIs on only one of the PUSCH repetitions 310 (e.g., may fall back to behavior 0 because the fifth condition is not satisfied). In such examples, the UE may transmit the first set of one or more UCIS and the second set of one or more UCIs according to behavior 0. The UE may transmit the first set of one or more UCIs via the first PUSCH repetition 310-a and the second set of one or more UCIs via the second PUSCH repetition 310-b, or may select one of the two PUSCH repetitions 310 and transmit both the first and second sets of UCIs via the selected single PUSCH repetition 310. In some examples, the UE may multiplex both the first set of one or more UCIs and the second set of one or more UCIs via both the first PUSCH repetition 310-a and the second PUSCH repetition 310-b according to behavior 1. In some examples, the UE may not expect to identify such conflicts (e.g., the UE may interpret such a case as an error case). In some examples, one or more standards documents may define such conflicts as an error case, and the network may avoid scheduling UCI according to the error case.

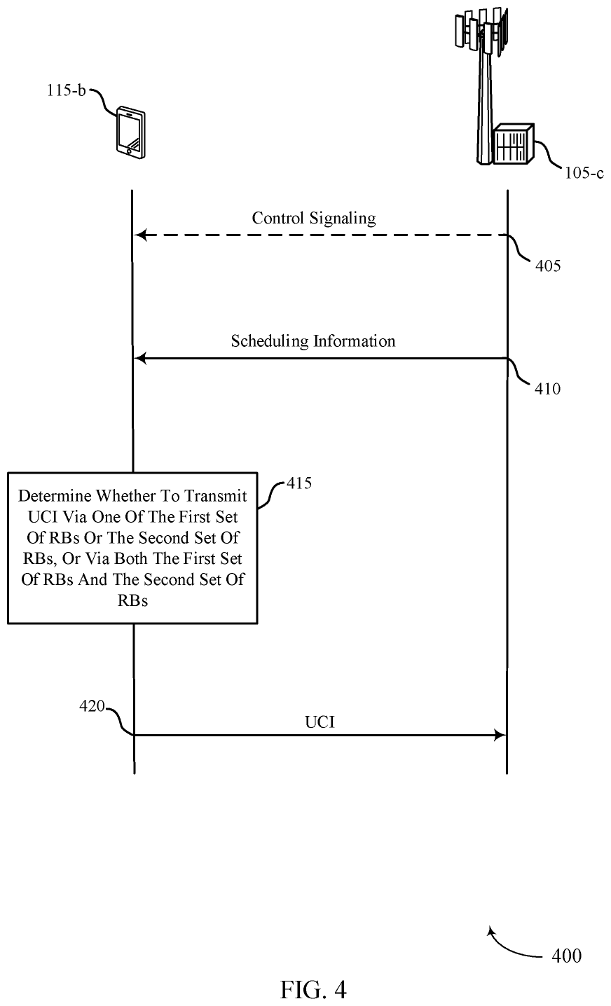

FIG. 4 illustrates an example of a process flow 400 that supports UCI multiplexing on FDM channels in accordance with one or more aspects of the present disclosure. The process flow 400 may implement aspects of, or be implemented by aspects of, the wireless communications system 100, the wireless communications system 200, and the timeline 300. For example, the process flow 400 may include a network entity 105-c, and a UE 115-b, which may be examples of corresponding devices described herein with reference to FIGS. 1-3.

At 410, the UE 115-b may receive (e.g., from the network entity 105-c) control signaling that may include scheduling information. For example, the control signaling may schedule a first set of RBs (e.g., a first set of RBs 210-a) associated with a first transmission beam and a second set of RBs (e.g., a second set of RBs 210-b) associated with a second transmission beam, wherein the first set of RBs and the second set of RBs occur during a first time interval.

At 415, the UE 115-b may determine, based at least in part on the control signaling received at 410, whether to transmit UCI via one of the first set of RBs or the second set of RBs (e.g., via a single set of RBs according to behavior 0), or via both the first set of RBs and the second set of RBs (e.g., via both sets of RBs according to behavior 1). At 420, the UE 115-b may transmit the UCI via at least one of the first set of RBs or the second set of RBs (e.g., according to behavior 0 or behavior 1) based at least in part on the determining at 415.

In some examples, the UE 115-b may determine whether to transmit the UCI according to behavior 1 or behavior 0 at 415 based at least in part on whether one or more conditions are satisfied. The UE 115-b may determine whether to transmit the UCI according to behavior 1 or behavior 0 at 415 based at least in part on whether a first quantity of RBs in the first set of RBs is equal to a second quantity of RBs in the second set of RBs (e.g., based on whether the first condition is satisfied). In some examples, the UE 115-b may determine whether to transmit the UCI according to behavior 1 or behavior 0 at 415 based at least in part on whether a first quantity of PTRS ports associated with the first set of RBs is equal to a second quantity of PTRS ports associated with the second set of RBs (e.g., based on whether the second condition is satisfied). The UE 115-b may determine whether to transmit the UCI according to behavior 1 or behavior 0 at 415 based at least in part on whether a first PTRS density associated with the first set of RBs is equal to a second PTRS density associated with the second set of RBs (e.g., based on whether the third condition is satisfied). In some examples, the UE 115-b may determine whether to transmit the UCI according to behavior 1 or behavior 0 at 415 based at least in part on whether a first quantity of resource elements of the first set of RBs is equal to a second quantity of resource elements of the second set of RBs (e.g., based on whether the fourth condition is satisfied). In some examples, the UE 115-b may determine whether to transmit the UCI according to behavior 1 or behavior 0 at 415 based at least in part on whether one or more additional UCI messages are scheduled during the first set of RBs or the second set of RBs (e.g., based on whether the fifth condition is satisfied).

In some examples, at 405, the UE 115-b may receive (e.g., from the network entity 105-c) second control signaling (e.g., RRC signaling) including an indication of a first trigger state associated with transmitting the UCI via one of the first set of RBs or the second set of RBs and a second trigger state associated with transmitting the UCI via both the first set of RBs and the second set of RBs. In such examples, the UE 115-b may receive, in the control signaling at 410 (e.g., a DCI message), an indication of the first trigger state or the second trigger state, and wherein the determining is based at least in part on the indication of the first trigger state or the second trigger state (e.g., enabling behavior 0 or behavior 1). In such examples, the trigger state may be associated with UCI including aperiodic CSI, SP-CSI associated with a PUSCH, among other examples.

In some examples, at 415, the UE 115 may determine whether a type of the UCI is associated with transmitting the UCI via the first set of RBs (e.g., behavior 0) or transmitting the UCI via both the first set of RBs and the second set of RBs (e.g., behavior 1). In some such examples, the UE 115-b may receive (e.g., at 405), control signaling (e.g., second control signaling) scheduling the UCI on a PUCCH that overlaps in time with the first set of RBs and the second set of RBs. The type of the UCI may be associated with the PUCCH. The UE 115-b may also receive control signaling (e.g., third control signaling) indicating that a first type of UCI is associated with transmitting the UCI via one of the first set of RBs or the second set of RBs, and a second type of UCI is associated with transmitting the UCI via both the first set of RBs and the second set of RBs, wherein the determining is based at least in part on whether the type of the UCI is the first type or the second type. The type of UCI may be feedback information (HARQ-ACK), an SR, SP-CSI associated with a PUSCH, or periodic CSI.

In some examples, where the UE 115-b determines to transmit the UCI via one of the first set of RBs or the second set of RBs (e.g., configured with or defaulting to behavior 0), the UE 115-b may select the first set of RBs based at least in part on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

In some examples, (e.g., at 405), the UE 115-b may receive second control signaling scheduling additional UCI via a control channel, wherein the determining includes determining to transmit the UCI via both the first set of RBs and the second set of RBs. In such examples, the UE 115-b may transmit the UCI and the additional UCI via the first set of RBs or the second set of RBs, or may transmit the UCI via the first set of RBs and the additional UCI via the second set of RBs, or may refrain from transmitting the additional UCI based at least in part on the error case.

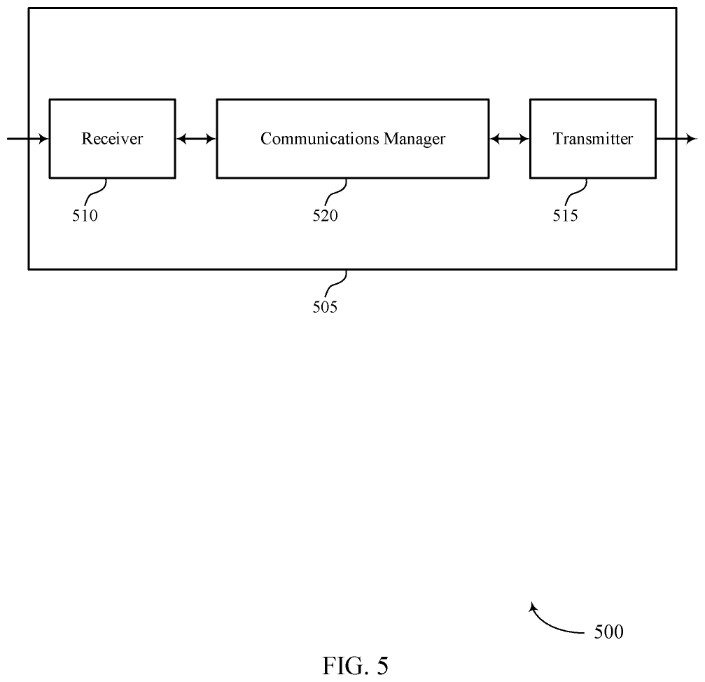

FIG. 5 shows a block diagram 500 of a device 505 that supports UCI multiplexing on FDM channels in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to UCI multiplexing on FDM channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UCI multiplexing on FDM channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of UCI multiplexing on FDM channels as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving control signaling that schedules a first set of RBs associated with a first transmission beam and a second set of RBs associated with a second transmission beam, where the first set of RBs and the second set of RBs occur during a first time interval. The communications manager 520 may be configured as or otherwise support a means for determining, based on the control signaling, whether to transmit UCI via one of the first set of RBs or the second set of RBs, or via both the first set of RBs and the second set of RBs. The communications manager 520 may be configured as or otherwise support a means for transmitting the UCI via at least one of the first set of RBs or the second set of RBs based on the determining.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for UCI signaling resulting in more efficient use of available system resources, mor reliable control signaling, improved reliability of communications, and improved user experience.

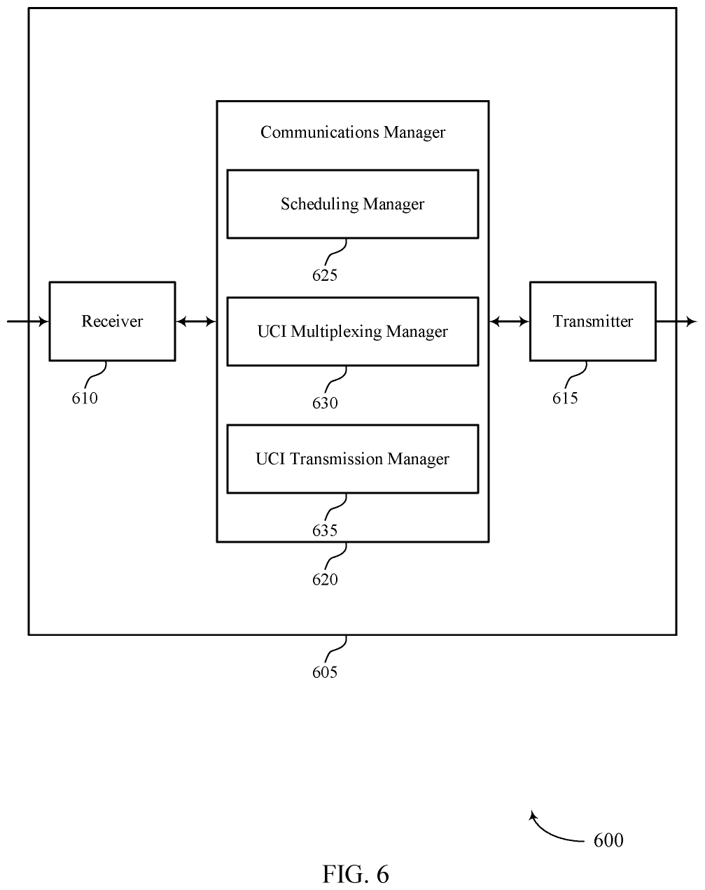

FIG. 6 shows a block diagram 600 of a device 605 that supports UCI multiplexing on FDM channels in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to UCI multiplexing on FDM channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UCI multiplexing on FDM channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of UCI multiplexing on FDM channels as described herein. For example, the communications manager 620 may include a scheduling manager 625, a UCI multiplexing manager 630, a UCI transmission manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The scheduling manager 625 may be configured as or otherwise support a means for receiving control signaling that schedules a first set of RBs associated with a first transmission beam and a second set of RBs associated with a second transmission beam, where the first set of RBs and the second set of RBs occur during a first time interval. The UCI multiplexing manager 630 may be configured as or otherwise support a means for determining, based on the control signaling, whether to transmit UCI via one of the first set of RBs or the second set of RBs, or via both the first set of RBs and the second set of RBs. The UCI transmission manager 635 may be configured as or otherwise support a means for transmitting the UCI via at least one of the first set of RBs or the second set of RBs based on the determining.

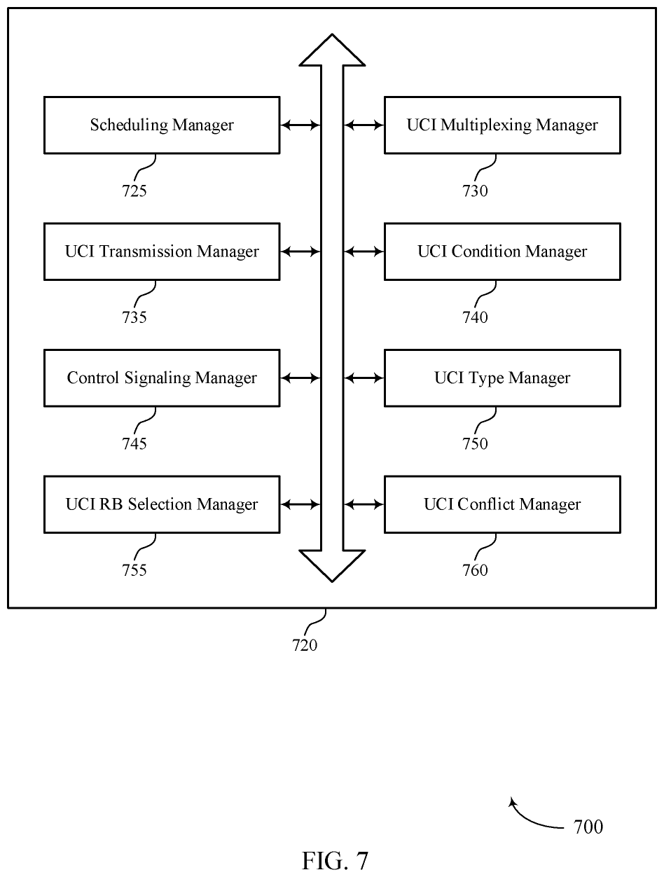

FIG. 7 shows a block diagram 700 of a communications manager 720 that supports UCI multiplexing on FDM channels in accordance with one or more aspects of the present disclosure. The communications manager 720 may be an example of aspects of a communications manager 520, a communications manager 620, or both, as described herein. The communications manager 720, or various components thereof, may be an example of means for performing various aspects of UCI multiplexing on FDM channels as described herein. For example, the communications manager 720 may include a scheduling manager 725, a UCI multiplexing manager 730, a UCI transmission manager 735, a UCI condition manager 740, a control signaling manager 745, a UCI type manager 750, a UCI RB selection manager 755, a UCI conflict manager 760, or any combination thereof. Each of these components may communicate, directly or indirectly, with one another (e.g., via one or more buses).

The communications manager 720 may support wireless communications at a UE in accordance with examples as disclosed herein. The scheduling manager 725 may be configured as or otherwise support a means for receiving control signaling that schedules a first set of RBs associated with a first transmission beam and a second set of RBs associated with a second transmission beam, where the first set of RBs and the second set of RBs occur during a first time interval. The UCI multiplexing manager 730 may be configured as or otherwise support a means for determining, based on the control signaling, whether to transmit UCI via one of the first set of RBs or the second set of RBs, or via both the first set of RBs and the second set of RBs. The UCI transmission manager 735 may be configured as or otherwise support a means for transmitting the UCI via at least one of the first set of RBs or the second set of RBs based on the determining.

In some examples, to support transmitting the UCI, the UCI condition manager 740 may be configured as or otherwise support a means for transmitting the UCI via the first set of RBs or via both the first set of RBs and the second set of RBs based on the determining and on whether one or more conditions are satisfied.

In some examples, to support transmitting the UCI, the UCI condition manager 740 may be configured as or otherwise support a means for transmitting the UCI via the first set of RBs or via both the first set of RBs and the second set of RBs based on whether a first quantity of RBs in the first set of RBs is equal to a second quantity of RBs in the second set of RBs.

In some examples, to support transmitting the UCI, the UCI condition manager 740 may be configured as or otherwise support a means for transmitting the UCI via the first set of RBs or via both the first set of RBs and the second set of RBs based on whether a first quantity of PTRS ports associated with the first set of RBs is equal to a second quantity of PTRS ports associated with the second set of RBs.

In some examples, to support transmitting the UCI, the UCI condition manager 740 may be configured as or otherwise support a means for transmitting the UCI via the first set of RBs or via both the first set of RBs and the second set of RBs based on whether a first PTRS density associated with the first set of RBs is equal to a second PTRS density associated with the second set of RBs.

In some examples, to support transmitting the UCI, the UCI condition manager 740 may be configured as or otherwise support a means for transmitting the UCI via the first set of RBs or via both the first set of RBs and the second set of RBs based on whether a first quantity of resource elements of the first set of RBs is equal to a second quantity of resource elements of the second set of RBs.

In some examples, to support transmitting the UCI, the UCI condition manager 740 may be configured as or otherwise support a means for transmitting the UCI via the first set of RBs or via both the first set of RBs and the second set of RBs based on whether one or more additional UCI messages are scheduled during the first set of RBs or the second set of RBs.

In some examples, the control signaling manager 745 may be configured as or otherwise support a means for receiving second control signaling including an indication of a first trigger state associated with transmitting the UCI via one of the first set of RBs or the second set of RBs and a second trigger state associated with transmitting the UCI via both the first set of RBs and the second set of RBs.

In some examples, the control signaling manager 745 may be configured as or otherwise support a means for receiving, in the control signaling, an indication of the first trigger state or the second trigger state, and where the determining is based on the indication of the first trigger state or the second trigger state.

In some examples, the UCI includes aperiodic channel state information, or SP-CSI associated with an uplink shared channel.

In some examples, to support determining, the UCI type manager 750 may be configured as or otherwise support a means for determining whether a type of the UCI is associated with transmitting the UCI via the first set of RBs or transmitting the UCI via both the first set of RBs and the second set of RBs.

In some examples, the UCI type manager 750 may be configured as or otherwise support a means for receiving second control signaling scheduling the UCI on a PUCCH that overlaps in time with the first set of RBs and the second set of RBs, where the type of the UCI is associated with the PUCCH.

In some examples, the UCI type manager 750 may be configured as or otherwise support a means for receiving third control signaling indicating that a first type of UCI is associated with transmitting the UCI via one of the first set of RBs or the second set of RBs, and a second type of UCI is associated with transmitting the UCI via both the first set of RBs and the second set of RBs, where the determining is based on whether the type of the UCI is the first type or the second type.

In some examples, the type of the UCI includes feedback information, a scheduling request, SP-CSI associated with a PUCCH, or periodic channel state information.

In some examples, to support determining, the UCI RB selection manager 755 may be configured as or otherwise support a means for determining to transmit the UCI via one of the first set of RBs or the second set of RBs. In some examples, to support determining, the UCI RB selection manager 755 may be configured as or otherwise support a means for selecting one of the first set of RBs or the second set of RBs based on the determining, where the transmitting is based on the selecting.

In some examples, to support selecting, the UCI RB selection manager 755 may be configured as or otherwise support a means for selecting the first set of RBs based on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

In some examples, the UCI conflict manager 760 may be configured as or otherwise support a means for receiving second control signaling scheduling additional UCI via a control channel, where the determining includes determining to transmit the UCI via both the first set of RBs and the second set of RBs.

In some examples, to support transmitting the UCI, the UCI conflict manager 760 may be configured as or otherwise support a means for transmitting the UCI and the additional UCI via the first set of RBs.

In some examples, to support transmitting the UCI, the UCI conflict manager 760 may be configured as or otherwise support a means for transmitting the UCI via the first set of RBs. In some examples, to support transmitting the UCI, the UCI conflict manager 760 may be configured as or otherwise support a means for transmitting the additional UCI via the second set of RBs.

In some examples, to support transmitting the UCI, the UCI conflict manager 760 may be configured as or otherwise support a means for transmitting the UCI via both the first set of RBs and the second set of RBs. In some examples, to support transmitting the UCI, the UCI conflict manager 760 may be configured as or otherwise support a means for transmitting the additional UCI via both the first set of RBs and the second set of RBs.

In some examples, the UCI conflict manager 760 may be configured as or otherwise support a means for identifying an error case based on receiving the control signaling scheduling the additional UCI. In some examples, the UCI conflict manager 760 may be configured as or otherwise support a means for refraining from transmitting the additional UCI based on the error case.

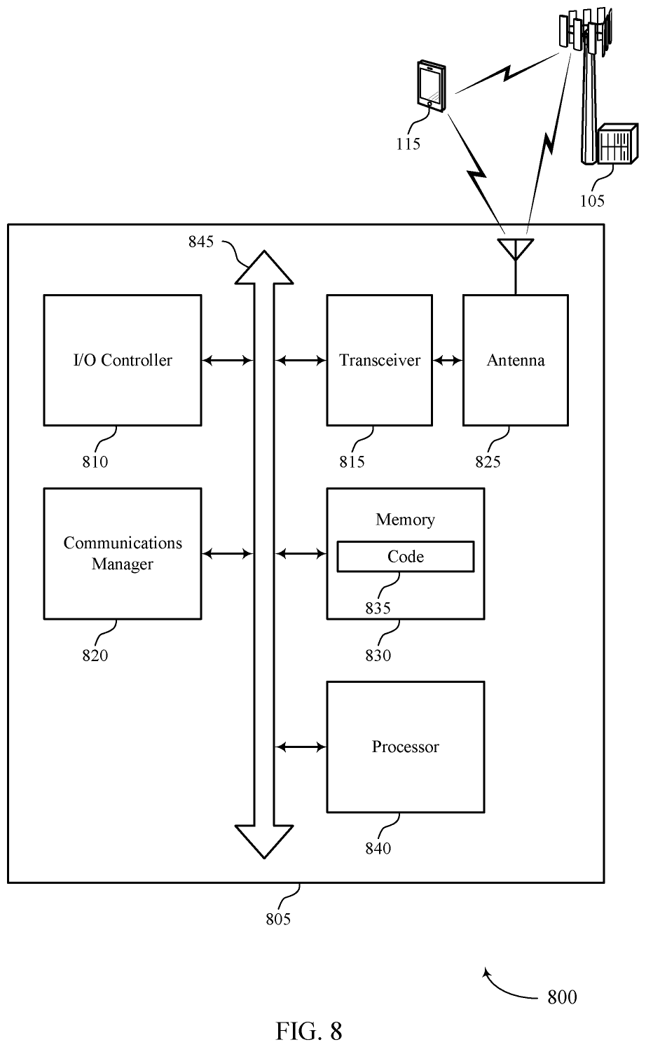

FIG. 8 shows a diagram of a system 800 including a device 805 that supports UCI multiplexing on FDM channels in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting UCI multiplexing on FDM channels). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving control signaling that schedules a first set of RBs associated with a first transmission beam and a second set of RBs associated with a second transmission beam, where the first set of RBs and the second set of RBs occur during a first time interval. The communications manager 820 may be configured as or otherwise support a means for determining, based on the control signaling, whether to transmit UCI via one of the first set of RBs or the second set of RBs, or via both the first set of RBs and the second set of RBs. The communications manager 820 may be configured as or otherwise support a means for transmitting the UCI via at least one of the first set of RBs or the second set of RBs based on the determining.

By including or configuring the communications manager 820 in accordance with examples as described herein, the device 805 may support techniques for UCI signaling resulting in more efficient use of available system resources, mor reliable control signaling, improved reliability of communications, decreased system latency, and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of UCI multiplexing on FDM channels as described herein, or the processor 840 and the memory 830 may be otherwise configured to perform or support such operations.

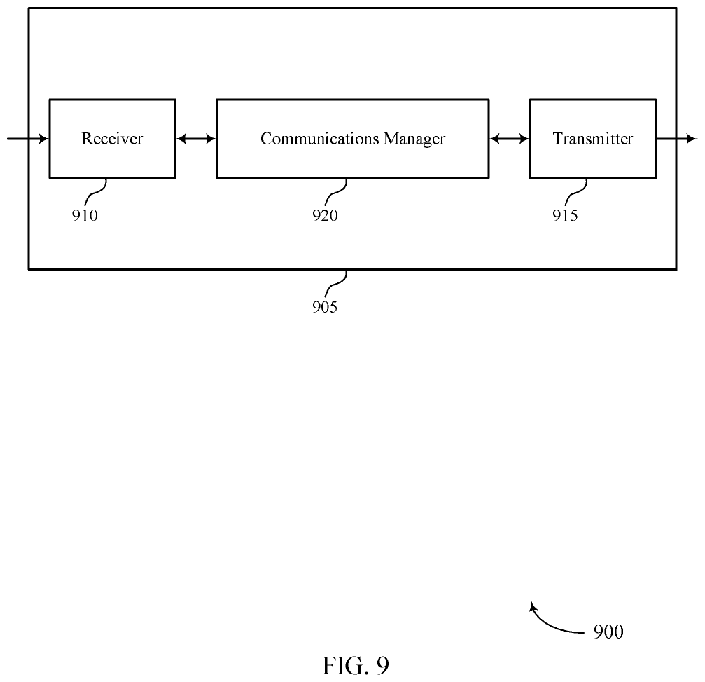

FIG. 9 shows a block diagram 900 of a device 905 that supports UCI multiplexing on FDM channels in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of UCI multiplexing on FDM channels as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting control signaling that schedules a first set of RBs associated with a first transmission beam of a UE and a second set of RBs associated with a second transmission beam of the UE, where the first set of RBs and the second set of RBs occur during a first time interval. The communications manager 920 may be configured as or otherwise support a means for determining, based on the control signaling, whether to receive UCI via one of the first set of RBs or the second set of RBs, or via both the first set of RBs and the second set of RBs. The communications manager 920 may be configured as or otherwise support a means for receiving the UCI via at least one of the first set of RBs or the second set of RBs based on the determining.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for UCI signaling resulting in more efficient use of available system resources, mor reliable control signaling, improved reliability of communications, and improved user experience.

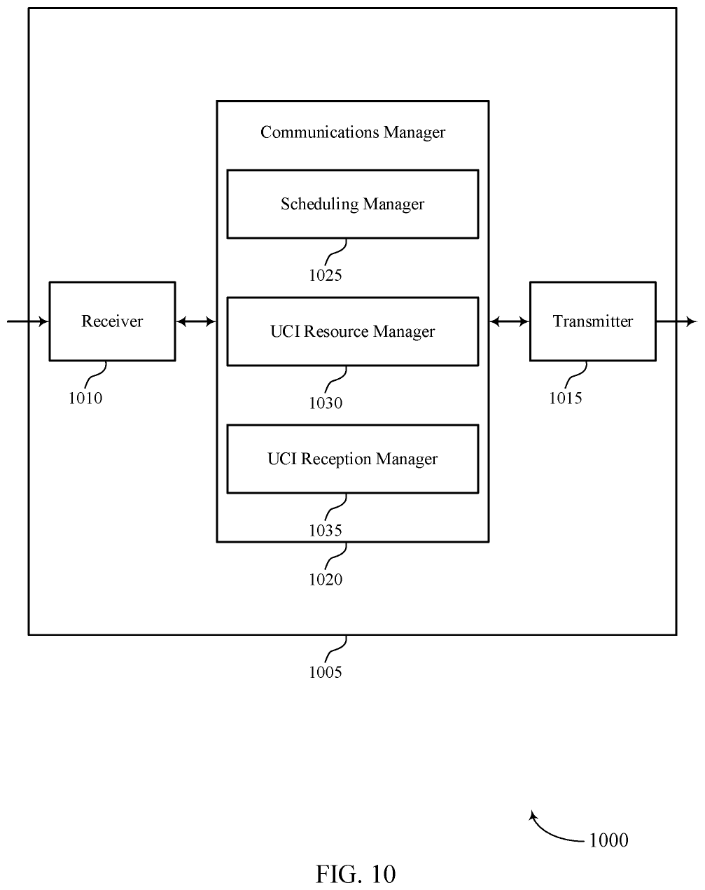

FIG. 10 shows a block diagram 1000 of a device 1005 that supports UCI multiplexing on FDM channels in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UCI multiplexing on FDM channels as described herein. For example, the communications manager 1020 may include a scheduling manager 1025, a UCI resource manager 1030, a UCI reception manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The scheduling manager 1025 may be configured as or otherwise support a means for transmitting control signaling that schedules a first set of RBs associated with a first transmission beam of a UE and a second set of RBs associated with a second transmission beam of the UE, where the first set of RBs and the second set of RBs occur during a first time interval. The UCI resource manager 1030 may be configured as or otherwise support a means for determining, based on the control signaling, whether to receive UCI via one of the first set of RBs or the second set of RBs, or via both the first set of RBs and the second set of RBs. The UCI reception manager 1035 may be configured as or otherwise support a means for receiving the UCI via at least one of the first set of RBs or the second set of RBs based on the determining.

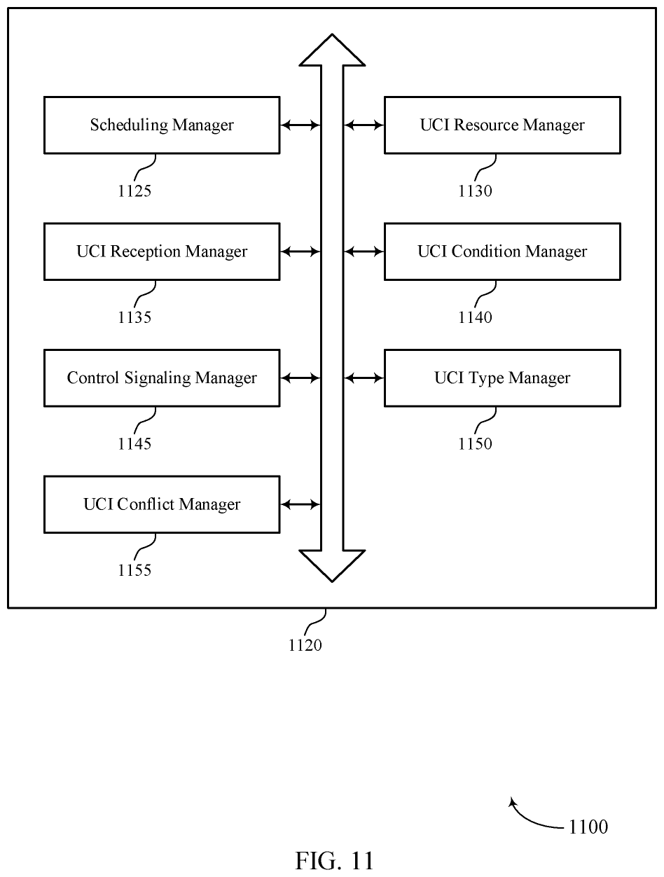

FIG. 11 shows a block diagram 1100 of a communications manager 1120 that supports UCI multiplexing on FDM channels in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UCI multiplexing on FDM channels as described herein. For example, the communications manager 1120 may include a scheduling manager 1125, a UCI resource manager 1130, a UCI reception manager 1135, a UCI condition manager 1140, a control signaling manager 1145, a UCI type manager 1150, a UCI conflict manager 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The scheduling manager 1125 may be configured as or otherwise support a means for transmitting control signaling that schedules a first set of RBs associated with a first transmission beam of a UE and a second set of RBs associated with a second transmission beam of the UE, where the first set of RBs and the second set of RBs occur during a first time interval. The UCI resource manager 1130 may be configured as or otherwise support a means for determining, based on the control signaling, whether to receive UCI via one of the first set of RBs or the second set of RBs, or via both the first set of RBs and the second set of RBs. The UCI reception manager 1135 may be configured as or otherwise support a means for receiving the UCI via at least one of the first set of RBs or the second set of RBs based on the determining.

In some examples, to support receiving the UCI, the UCI condition manager 1140 may be configured as or otherwise support a means for transmitting the UCI via the first set of RBs, or via both the first set of RBs and the second set of RBs based on the determining and on whether one or more conditions are satisfied.

In some examples, the control signaling manager 1145 may be configured as or otherwise support a means for transmitting second control signaling including an indication of a first trigger state associated with receiving the UCI via one of the first set of RBs or the second set of RBs and a second trigger state associated with receiving the UCI via both the first set of RBs and the second set of RBs.

In some examples, to support determining, the UCI type manager 1150 may be configured as or otherwise support a means for determining whether a type of the UCI is associated with receiving the UCI via the first set of RBs, or receiving the UCI via both the first set of RBs and the second set of RBs.

In some examples, to support determining, the UCI resource manager 1130 may be configured as or otherwise support a means for determining to receive the UCI via one of the first set of RBs or the second set of RBs. In some examples, to support determining, the UCI resource manager 1130 may be configured as or otherwise support a means for selecting one of the first set of RBs or the second set of RBs based on the determining, where the receiving is based on the selecting.

In some examples, to support selecting, the UCI resource manager 1130 may be configured as or otherwise support a means for selecting the first set of RBs based on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

In some examples, the UCI conflict manager 1155 may be configured as or otherwise support a means for transmitting second control signaling scheduling additional UCI via a control channel, where the determining includes determining to receive the UCI via both the first set of RBs and the second set of RBs.

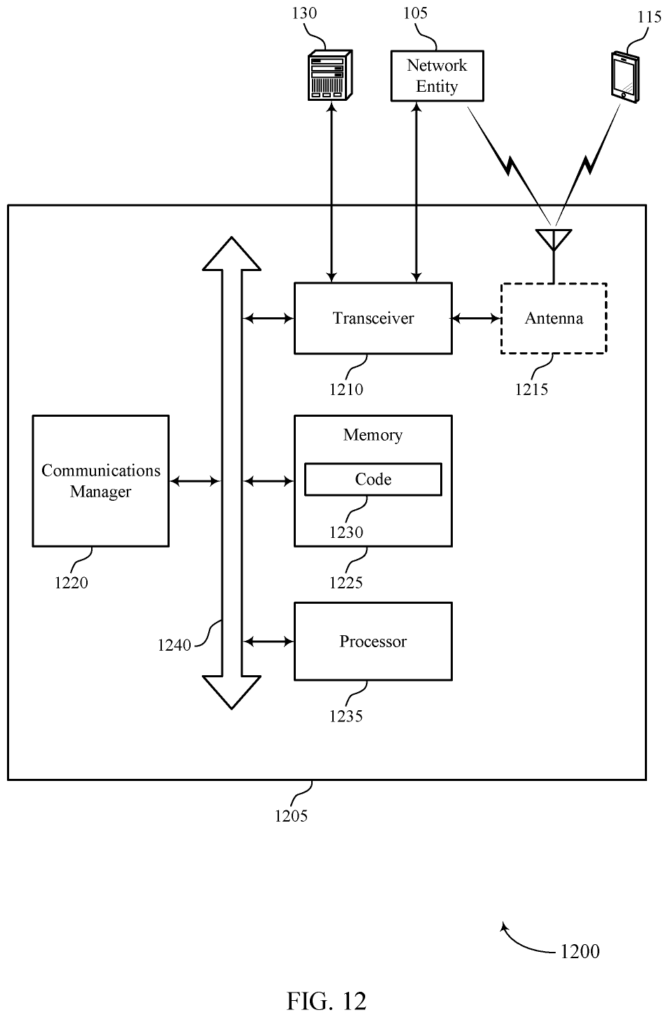

FIG. 12 shows a diagram of a system 1200 including a device 1205 that supports UCI multiplexing on FDM channels in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting UCI multiplexing on FDM channels). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting control signaling that schedules a first set of RBs associated with a first transmission beam of a UE and a second set of RBs associated with a second transmission beam of the UE, where the first set of RBs and the second set of RBs occur during a first time interval. The communications manager 1220 may be configured as or otherwise support a means for determining, based on the control signaling, whether to receive UCI via one of the first set of RBs or the second set of RBs, or via both the first set of RBs and the second set of RBs. The communications manager 1220 may be configured as or otherwise support a means for receiving the UCI via at least one of the first set of RBs or the second set of RBs based on the determining.

By including or configuring the communications manager 1220 in accordance with examples as described herein, the device 1205 may support techniques for UCI signaling resulting in more efficient use of available system resources, mor reliable control signaling, improved reliability of communications, decreased system latency, and improved user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of UCI multiplexing on FDM channels as described herein, or the processor 1235 and the memory 1225 may be otherwise configured to perform or support such operations.

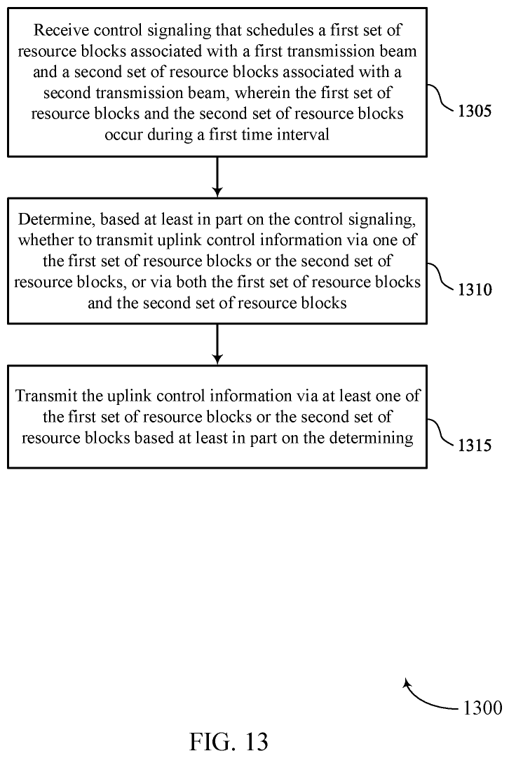

FIG. 13 shows a flowchart illustrating a method 1300 that supports UCI multiplexing on FDM channels in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that schedules a first set of RBs associated with a first transmission beam and a second set of RBs associated with a second transmission beam, where the first set of RBs and the second set of RBs occur during a first time interval. The operations of 1305 may be performed in accordance with examples as disclosed herein. In some examples, aspects of the operations of 1305 may be performed by a scheduling manager 725 as described with reference to FIG. 7.

At 1310, the method may include determining, based on the control signaling, whether to transmit UCI via one of the first set of RBs or the second set of RBs, or via both the first set of RBs and the second set of RBs. The operations of 1310 may be performed in accordance with examples as disclosed herein. In some examples, aspects of the operations of 1310 may be performed by a UCI multiplexing manager 730 as described with reference to FIG. 7.

At 1315, the method may include transmitting the UCI via at least one of the first set of RBs or the second set of RBs based on the determining. The operations of 1315 may be performed in accordance with examples as disclosed herein. In some examples, aspects of the operations of 1315 may be performed by a UCI transmission manager 735 as described with reference to FIG. 7.

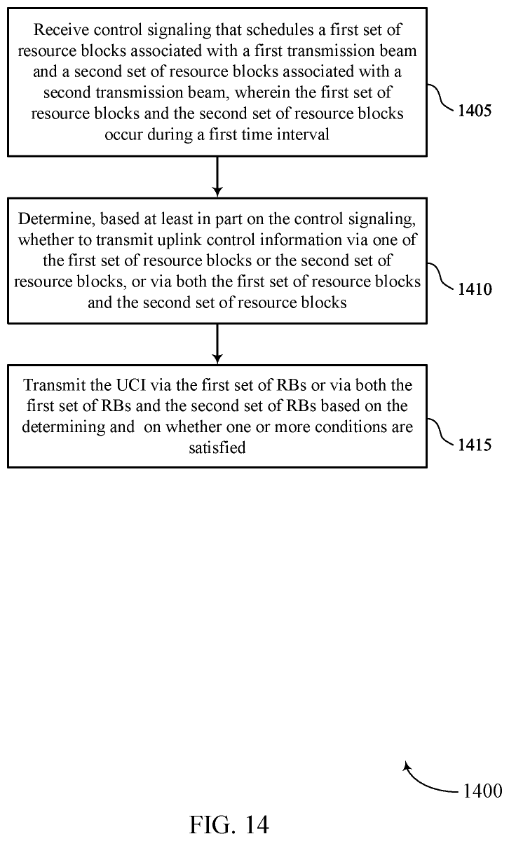

FIG. 14 shows a flowchart illustrating a method 1400 that supports UCI multiplexing on FDM channels in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that schedules a first set of RBs associated with a first transmission beam and a second set of RBs associated with a second transmission beam, where the first set of RBs and the second set of RBs occur during a first time interval. The operations of 1405 may be performed in accordance with examples as disclosed herein. In some examples, aspects of the operations of 1405 may be performed by a scheduling manager 725 as described with reference to FIG. 7.

At 1410, the method may include determining, based on the control signaling, whether to transmit UCI via one of the first set of RBs or the second set of RBs, or via both the first set of RBs and the second set of RBs. The operations of 1410 may be performed in accordance with examples as disclosed herein. In some examples, aspects of the operations of 1410 may be performed by a UCI multiplexing manager 730 as described with reference to FIG. 7.

At 1415, the method may include transmitting the UCI via the first set of RBs or via both the first set of RBs and the second set of RBs based on the determining and on whether one or more conditions are satisfied. The operations of 1415 may be performed in accordance with examples as disclosed herein. In some examples, aspects of the operations of 1415 may be performed a UCI condition manager 740 as described with reference to FIG. 7.

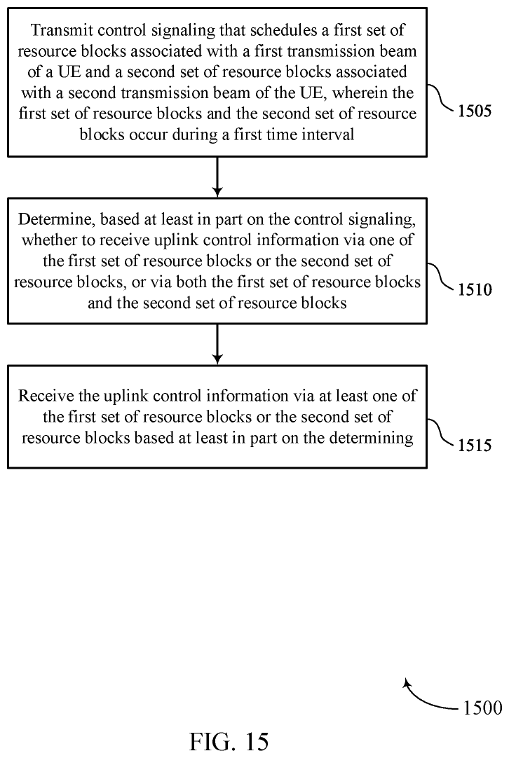

FIG. 15 shows a flowchart illustrating a method 1500 that supports UCI multiplexing on FDM channels in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling that schedules a first set of RBs associated with a first transmission beam of a UE and a second set of RBs associated with a second transmission beam of the UE, where the first set of RBs and the second set of RBs occur during a first time interval. The operations of 1505 may be performed in accordance with examples as disclosed herein. In some examples, aspects of the operations of 1505 may be performed by a scheduling manager 1125 as described with reference to FIG. 11.

At 1510, the method may include determining, based on the control signaling, whether to receive UCI via one of the first set of RBs or the second set of RBs, or via both the first set of RBs and the second set of RBs. The operations of 1510 may be performed in accordance with examples as disclosed herein. In some examples, aspects of the operations of 1510 may be performed by a UCI resource manager 1130 as described with reference to FIG. 11.

At 1515, the method may include receiving the UCI via at least one of the first set of RBs or the second set of RBs based on the determining. The operations of 1515 may be performed in accordance with examples as disclosed herein. In some examples, aspects of the operations of 1515 may be performed by a UCI reception manager 1135 as described with reference to FIG. 11.

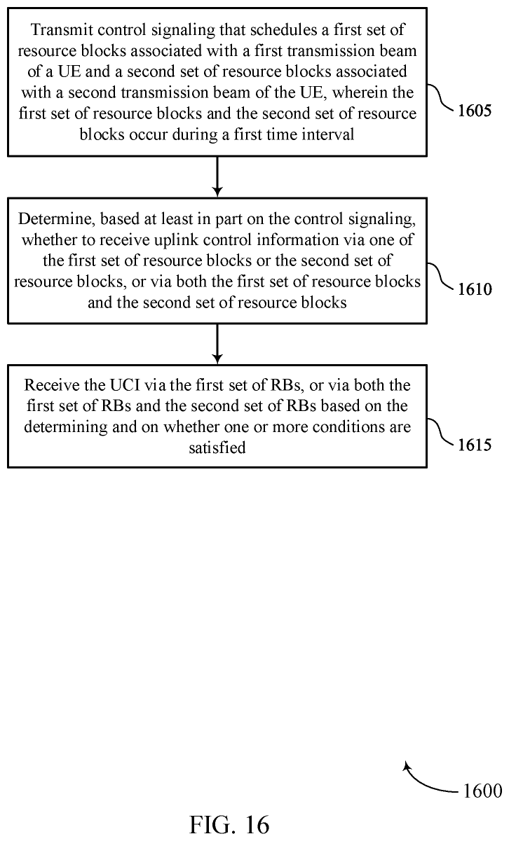

FIG. 16 shows a flowchart illustrating a method 1600 that supports UCI multiplexing on FDM channels in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling that schedules a first set of RBs associated with a first transmission beam of a UE and a second set of RBs associated with a second transmission beam of the UE, where the first set of RBs and the second set of RBs occur during a first time interval. The operations of 1605 may be performed in accordance with examples as disclosed herein. In some examples, aspects of the operations of 1605 may be performed by a scheduling manager 1125 as described with reference to FIG. 11.

At 1610, the method may include determining, based on the control signaling, whether to receive UCI via one of the first set of RBs or the second set of RBs, or via both the first set of RBs and the second set of RBs. The operations of 1610 may be performed in accordance with examples as disclosed herein. In some examples, aspects of the operations of 1610 may be performed by a UCI resource manager 1130 as described with reference to FIG. 11.

At 1615, the method may include receiving the UCI via the first set of RBs, or via both the first set of RBs and the second set of RBs based on the determining and on whether one or more conditions are satisfied. The operations of 1615 may be performed in accordance with examples as disclosed herein. In some examples, aspects of the operations of 1615 may be performed by a UCI condition manager 1140 as described with reference to FIG. 11.

The following provides an overview of aspects of the present disclosure:

Aspect 1: A method for wireless communications at a UE, comprising: receiving control signaling that schedules a first set of RBs associated with a first transmission beam and a second set of RBs associated with a second transmission beam, wherein the first set of RBs and the second set of RBs occur during a first time interval; determining, based at least in part on the control signaling, whether to transmit UCI via one of the first set of RBs or the second set of RBs, or via both the first set of RBs and the second set of RBs; and transmitting the UCI via at least one of the first set of RBs or the second set of RBs based at least in part on the determining.

Aspect 2: The method of aspect 1, wherein transmitting the UCI comprises: transmitting the UCI via the first set of RBs or via both the first set of RBs and the second set of RBs based at least in part on the determining and on whether one or more conditions are satisfied.

Aspect 3: The method of aspect 2, wherein transmitting the UCI comprises: transmitting the UCI via the first set of RBs or via both the first set of RBs and the second set of RBs based at least in part on whether a first quantity of RBs in the first set of RBs is equal to a second quantity of RBs in the second set of RBs.

Aspect 4: The method of any of aspects 2 through 3, wherein transmitting the UCI comprises: transmitting the UCI via the first set of RBs or via both the first set of RBs and the second set of RBs based at least in part on whether a first quantity of PTRS ports associated with the first set of RBs is equal to a second quantity of PTRS ports associated with the second set of RBs.

Aspect 5: The method of any of aspects 2 through 4, wherein transmitting the UCI comprises: transmitting the UCI via the first set of RBs or via both the first set of RBs and the second set of RBs based at least in part on whether a first PTRS density associated with the first set of RBs is equal to a second PTRS density associated with the second set of RBs.

Aspect 6: The method of any of aspects 2 through 5, wherein transmitting the UCI comprises: transmitting the UCI via the first set of RBs or via both the first set of RBs and the second set of RBs based at least in part on whether a first quantity of resource elements of the first set of RBs is equal to a second quantity of resource elements of the second set of RBs.

Aspect 7: The method of any of aspects 2 through 6, wherein transmitting the UCI comprises: transmitting the UCI via the first set of RBs or via both the first set of RBs and the second set of RBs based at least in part on whether one or more additional UCI messages are scheduled during the first set of RBs or the second set of RBs.

Aspect 8: The method of any of aspects 1 through 7, further comprising: receiving second control signaling comprising an indication of a first trigger state associated with transmitting the UCI via one of the first set of RBs or the second set of RBs and a second trigger state associated with transmitting the UCI via both the first set of RBs and the second set of RBs.

Aspect 9: The method of aspect 8, further comprising: receiving, in the control signaling, an indication of the first trigger state or the second trigger state, and wherein the determining is based at least in part on the indication of the first trigger state or the second trigger state.

Aspect 10: The method of any of aspects 8 through 9, wherein the UCI comprises aperiodic channel state information, or semi-persistent channel state information associated with an uplink shared channel.

Aspect 11: The method of any of aspects 1 through 10, wherein the determining comprises: determining whether a type of the UCI is associated with transmitting the UCI via the first set of RBs or transmitting the UCI via both the first set of RBs and the second set of RBs.

Aspect 12: The method of aspect 11, further comprising: receiving second control signaling scheduling the UCI on a physical uplink control channel that overlaps in time with the first set of RBs and the second set of RBs, wherein the type of the UCI is associated with the physical uplink control channel.

Aspect 13: The method of any of aspects 11 through 12, further comprising: receiving third control signaling indicating that a first type of UCI is associated with transmitting the UCI via one of the first set of RBs or the second set of RBs, and a second type of UCI is associated with transmitting the UCI via both the first set of RBs and the second set of RBs, wherein the determining is based at least in part on whether the type of the UCI is the first type or the second type.

Aspect 14: The method of any of aspects 11 through 13, wherein the type of the UCI comprises feedback information, a scheduling request, semi-persistent channel state information associated with a physical uplink control channel, or periodic channel state information.

Aspect 15: The method of any of aspects 1 through 14, wherein the determining comprises: determining to transmit the UCI via one of the first set of RBs or the second set of RBs; and selecting one of the first set of RBs or the second set of RBs based at least in part on the determining, wherein the transmitting is based at least in part on the selecting.

Aspect 16: The method of aspect 15, wherein the selecting comprises: selecting the first set of RBs based at least in part on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

Aspect 17: The method of any of aspects 1 through 16, further comprising: receiving second control signaling scheduling additional UCI via a control channel, wherein the determining comprises determining to transmit the UCI via both the first set of RBs and the second set of RBs.

Aspect 18: The method of aspect 17, wherein transmitting the UCI comprises: transmitting the UCI and the additional UCI via the first set of RBs.

Aspect 19: The method of any of aspects 17 through 18, wherein transmitting the UCI comprises: transmitting the UCI via the first set of RBs; and transmitting the additional UCI via the second set of RBs.

Aspect 20: The method of any of aspects 17 through 19, wherein transmitting the UCI comprises: transmitting the UCI via both the first set of RBs and the second set of RBs; and transmitting the additional UCI via both the first set of RBs and the second set of RBs.

Aspect 21: The method of any of aspects 17 through 20, further comprising: identifying an error case based at least in part on receiving the control signaling scheduling the additional UCI; and refraining from transmitting the additional UCI based at least in part on the error case.

Aspect 22: A method for wireless communications at a network entity, comprising: transmitting control signaling that schedules a first set of RBs associated with a first transmission beam of a UE and a second set of RBs associated with a second transmission beam of the UE, wherein the first set of RBs and the second set of RBs occur during a first time interval; determining, based at least in part on the control signaling, whether to receive UCI via one of the first set of RBs or the second set of RBs, or via both the first set of RBs and the second set of RBs; and receiving the UCI via at least one of the first set of RBs or the second set of RBs based at least in part on the determining.

Aspect 23: The method of aspect 22, wherein receiving the UCI comprises: the UCI via the first set of RBs, or via both the first set of RBs and the second set of RBs based at least in part on the determining and on whether one or more conditions are satisfied.

Aspect 24: The method of any of aspects 22 through 23, further comprising: transmitting second control signaling comprising an indication of a first trigger state associated with receiving the UCI via one of the first set of RBs or the second set of RBs and a second trigger state associated with receiving the UCI via both the first set of RBs and the second set of RBs.

Aspect 25: The method of any of aspects 22 through 24, wherein the determining comprises: determining whether a type of the UCI is associated with receiving the UCI via the first set of RBs, or receiving the UCI via both the first set of RBs and the second set of RBs.

Aspect 26: The method of any of aspects 22 through 25, wherein the determining comprises: determining to receive the UCI via one of the first set of RBs or the second set of RBs; and selecting one of the first set of RBs or the second set of RBs based at least in part on the determining, wherein the receiving is based at least in part on the selecting.

Aspect 27: The method of aspect 26, wherein the selecting comprises: selecting the first set of RBs based at least in part on a first sounding reference signal resource set associated with the first set of RBs, a frequency range associated with the first set of RBs, a redundancy version of a repetition associated with the first set of RBs, a quantity of RBs or resource elements associated with the first set of RBs, one or more additional UCI messages scheduled for the first set of RBs and the second set of RBs, or any combination thereof.

Aspect 28: The method of any of aspects 22 through 27, further comprising: transmitting second control signaling scheduling additional UCI via a control channel, wherein the determining comprises determining to receive the UCI via both the first set of RBs and the second set of RBs.

Aspect 29: An apparatus for wireless communications at a UE, comprising a processor; memory coupled with the processor; and instructions stored in the memory and executable by the processor to cause the apparatus to perform a method of any of aspects 1 through 21.

Aspect 30: An apparatus for wireless communications at a UE, comprising at least one means for performing a method of any of aspects 1 through 21.

Aspect 31: A non-transitory computer-readable medium storing code for wireless communications at a UE, the code comprising instructions executable by a processor to perform a method of any of aspects 1 through 21.

Aspect 32: An apparatus for wireless communications at a network entity, comprising a processor; memory coupled with the processor; and instructions stored in the memory and executable by the processor to cause the apparatus to perform a method of any of aspects 22 through 28.

Aspect 33: An apparatus for wireless communications at a network entity, comprising at least one means for performing a method of any of aspects 22 through 28.

Aspect 34: A non-transitory computer-readable medium storing code for wireless communications at a network entity, the code comprising instructions executable by a processor to perform a method of any of aspects 22 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive control signaling that schedules a first set of resource blocks associated with a first transmission beam and a second set of resource blocks associated with a second transmission beam, wherein the first set of resource blocks and the second set of resource blocks occur during a first time interval;
determine, based at least in part on the control signaling, whether to transmit uplink control information via one of the first set of resource blocks or the second set of resource blocks, or via both the first set of resource blocks and the second set of resource blocks; and
transmit the uplink control information via at least one of the first set of resource blocks or the second set of resource blocks based at least in part on the determining.

2. The apparatus of claim 1, wherein the instructions to transmit the uplink control information are executable by the processor to cause the apparatus to:
transmit the uplink control information via the first set of resource blocks or via both the first set of resource blocks and the second set of resource blocks based at least in part on the determining and on whether one or more conditions are satisfied.

3. The apparatus of claim 2, wherein the instructions to transmit the uplink control information are executable by the processor to cause the apparatus to:
transmit the uplink control information via the first set of resource blocks or via both the first set of resource blocks and the second set of resource blocks based at least in part on whether a first quantity of resource blocks in the first set of resource blocks is equal to a second quantity of resource blocks in the second set of resource blocks.

4. The apparatus of claim 2, wherein the instructions to transmit the uplink control information are executable by the processor to cause the apparatus to:
transmit the uplink control information via the first set of resource blocks or via both the first set of resource blocks and the second set of resource blocks based at least in part on whether a first quantity of PTRS ports associated with the first set of resource blocks is equal to a second quantity of PTRS ports associated with the second set of resource blocks.

5. The apparatus of claim 2, wherein the instructions to transmit the uplink control information are executable by the processor to cause the apparatus to:
transmit the uplink control information via the first set of resource blocks or via both the first set of resource blocks and the second set of resource blocks based at least in part on whether a first PTRS density associated with the first set of resource blocks is equal to a second PTRS density associated with the second set of resource blocks.

6. The apparatus of claim 2, wherein the instructions to transmit the uplink control information are executable by the processor to cause the apparatus to:
transmit the uplink control information via the first set of resource blocks or via both the first set of resource blocks and the second set of resource blocks based at least in part on whether a first quantity of resource elements of the first set of resource blocks is equal to a second quantity of resource elements of the second set of resource blocks.

7. The apparatus of claim 2, wherein the instructions to transmit the uplink control information are executable by the processor to cause the apparatus to:
transmit the uplink control information via the first set of resource blocks or via both the first set of resource blocks and the second set of resource blocks based at least in part on whether one or more additional uplink control information messages are scheduled during the first set of resource blocks or the second set of resource blocks.

8. The apparatus of claim 1, wherein the instructions are further executable by the processor to cause the apparatus to:
receive second control signaling comprising an indication of a first trigger state associated with transmitting the uplink control information via one of the first set of resource blocks or the second set of resource blocks and a second trigger state associated with transmitting the uplink control information via both the first set of resource blocks and the second set of resource blocks.

9. The apparatus of claim 8, wherein the instructions are further executable by the processor to cause the apparatus to:
receive, in the control signaling, an indication of the first trigger state or the second trigger state, and wherein the determining is based at least in part on the indication of the first trigger state or the second trigger state.

10. The apparatus of claim 8, wherein the uplink control information comprises aperiodic channel state information, or semi-persistent channel state information associated with an uplink shared channel.

11. The apparatus of claim 1, wherein the instructions to determine are executable by the processor to cause the apparatus to:
determine whether a type of the uplink control information is associated with transmitting the uplink control information via the first set of resource blocks or transmitting the uplink control information via both the first set of resource blocks and the second set of resource blocks.

12. The apparatus of claim 11, wherein the instructions are further executable by the processor to cause the apparatus to:
receive second control signaling scheduling the uplink control information on a physical uplink control channel that overlaps in time with the first set of resource blocks and the second set of resource blocks, wherein the type of the uplink control information is associated with the physical uplink control channel.

13. The apparatus of claim 11, wherein the instructions are further executable by the processor to cause the apparatus to:
receive third control signaling indicating that a first type of uplink control information is associated with transmitting the uplink control information via one of the first set of resource blocks or the second set of resource blocks, and a second type of uplink control information is associated with transmitting the uplink control information via both the first set of resource blocks and the second set of resource blocks, wherein the determining is based at least in part on whether the type of the uplink control information is the first type or the second type.

14. The apparatus of claim 11, wherein the type of the uplink control information comprises:
feedback information, a scheduling request, semi-persistent channel state information associate with a physical uplink control channel, or periodic channel state information.

15. The apparatus of claim 1, wherein the instructions to determine are executable by the processor to cause the apparatus to:
determine to transmit the uplink control information via one of the first set of resource blocks or the second set of resource blocks; and
select one of the first set of resource blocks or the second set of resource blocks based at least in part on the determining, wherein the transmitting is based at least in part on the selecting.

16. The apparatus of claim 15, wherein the instructions to select are executable by the processor to cause the apparatus to:
select the first set of resource blocks based at least in part on a first sounding reference signal resource set associated with the first set of resource blocks, a frequency range associated with the first set of resource blocks, a redundancy version of a repetition associated with the first set of resource blocks, a quantity of resource blocks or resource elements associated with the first set of resource blocks, one or more additional uplink control information messages scheduled for the first set of resource blocks and the second set of resource blocks, or any combination thereof.

17. The apparatus of claim 1, wherein the instructions are further executable by the processor to cause the apparatus to:
receive second control signaling scheduling additional uplink control information via a control channel, wherein the determining comprises determining to transmit the uplink control information via both the first set of resource blocks and the second set of resource blocks.

18. The apparatus of claim 17, wherein the instructions to transmit the uplink control information are executable by the processor to cause the apparatus to:
transmit the uplink control information and the additional uplink control information via the first set of resource blocks.

19-21. (canceled)

22. An apparatus for wireless communications at a network entity, comprising:
a processor;
memory coupled with the processor; and
instructions stored in the memory and executable by the processor to cause the apparatus to:
transmit control signaling that schedules a first set of resource blocks associated with a first transmission beam of a user equipment (UE) and a second set of resource blocks associated with a second transmission beam of the UE, wherein the first set of resource blocks and the second set of resource blocks occur during a first time interval;
determine, based at least in part on the control signaling, whether to receive uplink control information via one of the first set of resource blocks or the second set of resource blocks, or via both the first set of resource blocks and the second set of resource blocks; and
receive the uplink control information via at least one of the first set of resource blocks or the second set of resource blocks based at least in part on the determining.

23-28. (canceled)

29. A method for wireless communications at a user equipment (UE), comprising:
receiving control signaling that schedules a first set of resource blocks associated with a first transmission beam and a second set of resource blocks associated with a second transmission beam, wherein the first set of resource blocks and the second set of resource blocks occur during a first time interval;
determining, based at least in part on the control signaling, whether to transmit uplink control information via one of the first set of resource blocks or the second set of resource blocks, or via both the first set of resource blocks and the second set of resource blocks; and
transmitting the uplink control information via at least one of the first set of resource blocks or the second set of resource blocks based at least in part on the determining.

30. (canceled)
